(19) United States
(12) Patent Application Publication
(10) Pub. No.: US 2022/0390211 A1
(43) Pub. Date: Dec. 8, 2022

(54) ANTI-BALLISTIC BARRIERS AND METHODS OF MANUFACTURE

(71) Applicant: John B. Adrain, Spokane, WA (US)

(72) Inventor: John B. Adrain, Spokane, WA (US)

(21) Appl. No.: 17/888,246

(22) Filed: Aug. 15, 2022

Related U.S. Application Data
(63) Continuation-in-part of application No. 17/006,424, filed on Aug. 28, 2020.
Application No. 17/006,424 is a continuation-in-part of application No. 16/215,162, filed on Dec. 10, 2018, now Pat. No. 10,801,815.
Application No. 16/215,162 is a continuation-in-part of application No. 15/050,639, filed on Feb. 23, 2016, now Pat. No. 10,151,566.
Application No. 15/050,639 is a continuation-in-part of application No. 14/476,206, filed on Sep. 3, 2014, now Pat. No. 10,473,437.
Application No. 14/476,206 is a continuation-in-part of application No. PCT/US22/22860, filed on Mar. 31, 2022.
(60) Provisional application No. 62/892,899, filed on Aug. 28, 2019.
(60) Provisional application No. 62/911,323, filed on Oct. 6, 2019.
(60) Provisional application No. 61/873,073, filed on Sep. 3, 2013.
(60) Provisional application No. 62/119,510, filed on Feb. 23, 2015.
(60) Provisional application No. 63/169,783, filed on Apr. 1, 2021.

(51) Int. Cl. F41H 5/04

(52) U.S. Cl. CPC F41H 5/0478

(57) ABSTRACT

Laminates and their process of manufacture, with the laminates made with anti-ballistic materials, such as woven and unwoven fabrics. The laminates are provided with different structures, materials, bondings, and other features, and example methods of manufacturing those laminates efficiently and in mass quantities. The method of production is a process of laminating individual flexible sheets including anti-ballistic material (which may be of woven or unwoven cloth or thin solid sheets or foils comprised of one or more light-weight anti-ballistic materials) into a flexible laminate for use to protect people or spaces from ballistic objects such as bullets and shrapnel from weapons and other moderate to high-kinetic energy objects. Also, an anti-ballistic protection system for protecting an interior space in a building. The ballistic barrier includes the laminated material having a plurality of layers of lightweight, flexible, ballistic resistant material such as woven sheets which are secured together into the laminate using a adhesive, heat weld, or stitching. The ballistic barrier is configured to be in a compact retracted state which can be deployed to provide a protective state to protect against kinetic ballistic projectiles.

### CROSS-REFERENCES TO RELATED APPLICATIONS

This application is a continuation-in-part of U.S. patent application Ser. No. 17/006,424 filed on Aug. 28, 2020, which is a continuation-in-part of U.S. Pat. No. 10,801,815B2, filed on Dec. 10, 2018, which is a continuation-in-part of granted U.S. Pat. No. 10,151,566, filed on Feb. 23, 2016, which is a continuation-in-part of granted U.S. Pat. No. 10,473,437 filed on Sep. 3, 2014, which claims the benefit of U.S. Provisional Application No. 61/873,073, filed on Sep. 3, 2013, all incorporated herein by reference. U.S. Pat. No. 10,151,566 claims the benefit of U.S. Provisional Application No. 62/119,510 filed on Feb. 23, 2015. U.S. patent application Ser. No. 17/006,424 also claims the benefit of U.S. Provisional Application No. 62/892,899 filed on Aug. 28, 2019, and U.S. Provisional Application No. 62/911,323 filed on Oct. 6, 2019, all also incorporated herein by reference.

This application is also a continuation-in-part of PCT application serial number PCT/US22/22860 filed on Mar. 31, 2022, which claims the benefit of U.S. provisional patent application No. 63/169,783 filed on Apr. 1, 2021, both incorporated herein by reference in their entirety

### BACKGROUND

Various types of barriers, such as window blinds, such as venetian blinds, and vertical blinds, screens, shields, etc. may be used in residential and commercial applications as window coverings, screens, barriers, etc. to act as a physical barrier to protect interior spaces, and because of their ability to selectively vary the amount of light passing through a window, glass door, skylight, or the like, by the varying deployment, or adjustment of a plurality of vanes, louvers or slats.

Current anti-ballistic protection systems in residential and commercial applications, such as armored doors, shutters, and windows, among others, are usually made of metal or a material containing at least one metal plate or other solid component, such as a dense glass or ceramic material, and thus having an extremely high weight. Some plastic systems exist that have lower weight, but that are very flimsy and weak, and thus would provide no protection from projectiles or other forced entry into the dwelling.

It would be useful to utilize various types of barriers to provide unauthorized entry protection to individuals and organizations in residential, commercial, government, federal building and mobile or any suitable application. It would also be useful to provide the components necessary to product such barriers in mass production.

### SUMMARY

The following presents a simplified summary in order to provide a basic understanding of some example aspects described in the detailed description.

Generally, provided are a plurality of example laminates and their process of manufacture, with the laminates having different structures, materials, bondings, and other features, and example methods of manufacturing those laminates efficiently and in mass quantities. The laminates should have sufficient width to support the desired end products and should be provided in long lengths to support mass manufacturing of the end products. The method of production is a process of laminating individual flexible sheets of material (which may be of woven or unwoven cloth, thin sheets, or foils comprised of one or more light-weight anti-ballistic materials) into a laminated layer of flexible material for use to protect people or spaces from ballistic objects from weapons and other moderate to high-kinetic energy objects.

Provided are a plurality of example embodiments, including, but not limited to, a method of producing a flexible ballistic resistant laminate comprising the steps of: feeding a first sheet of material including a ballistic resistant material into a bonding process; feeding a second sheet of material into the bonding process; feeding a third sheet of material into the bonding process; and using said bonding process to bond said first sheet of material, said second sheet of material, and said third sheet of material together to form said flexible ballistic resistant laminate, such that said flexible ballistic resistant laminate is sufficiently flexible to be rolled into a roll; and such that said flexible ballistic resistant laminate is configured to prevent a ballistic object including a bullet and/or explosive shrapnel from penetrating the flexible ballistic resistant laminate.

Also provided is a method of producing a continuous length of flexible ballistic resistant laminate comprising the steps of: feeding a continuous length of a first sheet of material including a ballistic resistant material into a bonding process; feeding a continuous length of a second sheet of material into the bonding process; feeding a continuous length of a third sheet of material into the bonding process; and using said bonding process to bond said first sheet of material, said second sheet of material, and said third sheet of material together to form said continuous length of flexible ballistic resistant laminate, such that said continuous length of flexible ballistic resistant laminate is sufficiently flexible to be rolled into a roll; and such that said flexible ballistic resistant laminate is configured to prevent a ballistic object including a bullet and/or explosive shrapnel from penetrating the flexible ballistic resistant laminate.

Further provided is a method of producing a continuous length of flexible ballistic resistant laminate comprising the steps of: feeding a continuous length of a first sheet of material including a first ballistic resistant material into a bonding process; feeding a continuous length of a second sheet of including said first ballistic resistant material and/or a second ballistic resistant material into the bonding process; feeding a continuous length of a third sheet including said first ballistic resistant material, and/or said second ballistic resistant material, and/or a third ballistic resistant material into the bonding process; and using said bonding process to bond said first sheet of material, said second sheet of material, and said third sheet of material together to form said continuous length of flexible ballistic resistant laminate. Optionally the step of adding an outer decorative layer to the continuous length of flexible ballistic resistant laminate. Such that said flexible ballistic resistant laminate is configured to prevent a ballistic object including a bullet and/or explosive shrapnel from penetrating the flexible ballistic resistant laminate.

Still further provided is a continuous length of flexible ballistic resistant laminate produced by any of the above methods, such as one comprising: a first layer comprising a continuous length of a first sheet of material including a ballistic resistant material; a second layer comprising a continuous length of a second sheet of including said ballistic resistant material and/or a second ballistic resistant material; a third layer comprising a continuous length of a third sheet of including said ballistic resistant material, and/or a second ballistic resistant material, and/or a third ballistic material, such that said first layer, said second layer, and said third layer are bonded together to form said continuous length of flexible ballistic resistant laminate that is configured to be rolled onto a roll, and such that said flexible ballistic resistant laminate is configured to prevent a ballistic object including a bullet and/or explosive shrapnel from penetrating the flexible ballistic resistant laminate.

Also provided is a barrier comprising material having anti-ballistic properties to prevent penetration by a ballistic projectile, such as a bullet, using any of the above flexible ballistic resistant laminates.

In one aspect, a system for protecting a space from ballistic objects using a deployable barrier is provided, comprising: a mounting structure configured for storing the deployable barrier in a retracted position; the deployable barrier comprising a flexible anti-ballistic material formed into a flexible sheet; and a deployment mechanism configured to drop the deployable barrier into a deployed position such that the barrier protects the space from entry by a ballistic object, said barrier being configured to flex and move in response to impact from the ballistic object to absorb energy from the ballistic object to further protect said space from the ballistic object.

In another aspect, a barrier system is disclosed herein including a control system operably configured to cause a change in state of the barrier from an open or retracted state to a protective state; and a sensing system operably configured to detect a threatening event, in which the sensing system upon sensing the threatening event triggers the control system to transition to the protective state.

In still another aspect, the above barrier systems may be configured to secure sides and/or bottoms of the barrier, when deployed, to prevent an individual or large object from entering the space.

In another aspect, a blind system is disclosed herein including a plurality of slats having a ballistic resistant material; a control system operably configured to cause a change in state of the blind from an open state to a protective closed state; and a sensing system operably configured to detect a threatening event, wherein the sensing system upon sensing the threatening event triggers the control system to transition from the open state to the protective state such that in the protective state, the blinds are adapted to be resistant to penetration by high-speed ballistic objects.

In yet another aspect, a blind system is disclosed herein including a blind suspended from a rail and a blind adjustment system that is configured to transition the blinds from an open state to a closed, protective state in which the blinds are adapted to be resistant to penetration by high-speed ballistic objects.

In still another aspect, decorative blinds are provided separate from blinds that provide ballistic protection, with the ballistic blinds being provided in an undeployed state, being deployed when a threatening situation is detected.

In still another aspect, an anti-ballistic window blind system is provided that is configured for providing in the window of a structure having an interior, the system comprising: a valance configured to be mounted at a window; a blind suspended from the valance and configured to be retracted toward the valence to expose the window and deployed from the valence to cover at least a portion of the window, the blind comprising a plurality of slats, wherein each of the slats is comprised of a non-metallic material having anti-ballistic properties, and wherein the slats are configured to be rotatable when the blind is deployed from the valence for allowing light from the window through the blind; and mechanical components associated with the valence for automatically deploying the blind into an anti-ballistic protection mode for protecting the interior of the structure from ballistic objects attempting to enter through the window.

In a further aspect, an anti-ballistic window blind system is provided that is configured for providing in the window of a structure having an interior, the system comprising: a mounting structure; a blind suspended from the mounting structure and configured to be retracted toward the mounting structure to expose the window and deployed from the mounting structure to cover at least a portion of the window, the blind comprising non-metallic material having anti-ballistic properties; mechanical components associated with the mounting structure for automatically deploying the blind into an anti-ballistic protection mode for protecting the interior of the structure from ballistic objects attempting to enter through the window; a sensing system for detecting threat data indicating a ballistic threat exists; and a control system configured to receive the threat data from the sensor, the control system operably configured to trigger the mechanical components to automatically deploy the blind into the anti-ballistic protection mode based on the received threat data.

In still another aspect, anti-ballistic window blind system is provided that is configured for providing in the window of a structure having an interior, the system comprising: a valance configured to be mounted at a window; a blind suspended from the valance and configured to be retracted toward the valence to expose the window and deployed from the valence to cover at least a portion of the window, the blind comprising a plurality of slats, wherein each of the slats is comprised of a non-metallic material having anti-ballistic properties, and wherein the slats are configured to be rotatable when the blind is deployed from the valence for allowing light from the window through the blind; mechanical components associated with the valence for automatically deploying the blind into an anti-ballistic protection mode for protecting the interior of the structure from ballistic objects attempting to enter through the window, wherein the automatically deploying the blind into an anti-ballistic protection mode includes rotating the slats into a closed position if the slats were in an open position, and/or automatically deploying the blind if the blind was in a retracted position; a sensing system for detecting threat data indicating a ballistic threat exists; a control system configured to receive the threat data from the sensor, the control system operably configured to trigger the mechanical components to automatically deploy the blind into the anti-ballistic protection mode based on the received threat data; and a user actuated device configured to trigger the control system to deploy the blind into the anti-ballistic protection mode when actuated.

The blinds provides an anti-entry function, such as a bullet proof system characterized by light weight, high ballistic resistant vanes, louvers or slats for application in a simple, yet unconventional manner.

Also provided is system of protecting a space from ballistic objects using a deployable blind, comprising: a mounting structure configured for storing the deployable blind in a retracted position; the deployable blind comprising an anti-ballistic laminate including a plurality of layers of flexible anti-ballistic material and at least one outer decorative layer with all said layers being secured together into a flexible sheet or slat; and a deployment mechanism configured to drop the blind into a deployed position such that the blind hangs from the mounting structure in a movable manner not secured on a bottom of the blind allowing the blind to flex and move in response to impact from a ballistic object to protect said space from the ballistic object.

Further provided is a system of protecting a space from ballistic objects using a deployable blind, comprising: a mounting structure configured for storing the deployable blind in a retracted position; the deployable blind comprising an anti-ballistic laminate including more than two layers of flexible anti-ballistic material and at least one outer decorative layer with all said layers being secured together into a flexible sheet or slat using stitching; a deployment mechanism configured to drop the blind into a deployed position such that the blind hangs from the mounting structure in a movable manner not secured on a bottom of the blind allowing the blind to flex and move in response to impact from a ballistic object to protect said space from the ballistic object.

Any of the above systems may utilize manual or automated deployment mechanisms to protect a room or space from a ballistic threat.

This summary is not an extensive overview of the features and systems discussed herein. It is not intended to identify key/critical elements or to delineate the scope of such features and systems. Its sole purpose is to present some concepts in a simplified form as a prelude to the more detailed description.

### BRIEF DESCRIPTION OF THE DRAWINGS

The features and advantages of the example embodiments described herein will become apparent to those skilled in the art to which this disclosure relates upon reading the following description, with reference to the accompanying drawings, which show some of the example embodiments of the disclosed devices.

FIGS. 1-5 are schematic diagrams of side cut views of various example embodiments of laminates that can be manufactured according to one or more of the disclosed methods;

FIG. 6 is a schematic diagram of a top view of a laminate that is bonded using stitching;

FIG. 7 shows a side cut view of a laminate that is bonded using an adhesive;

FIGS. 8-10 are schematic diagrams of various example manufacturing processes for producing laminates such as those shown in FIGS. 1-6, among others;

FIG. 10A illustrates an example laminated structure for blind slats that provide both decorative and anti-ballistic features;

FIG. 11 is a schematic diagram of a cutting/slitting process for further processing a laminate produced as provided herein;

FIG. 12 is a schematic diagram of a side cut view of any of the laminates disclosed herein with added edge caps;

FIG. 13 illustrates another example laminate having a plurality of layers;

FIG. 14 illustrates an example laminated structure for blind slats or sheets that utilize stitching;

FIG. 15 illustrates another example laminated structure for blinds that provide a plurality of layers having a hollow interior;

FIG. 16 illustrates an example installation of a vehicle shade system for an automobile.

FIG. 17 illustrates an example of a generic barrier.

FIG. 18 illustrates an example of a generic barrier window blind.

FIGS. 19A and 19B illustrates example of a generic barrier window blind using slats.

FIG. 20 illustrates another example embodiment of a blind system adapted for automatic deployment with remote control; and

FIG. 21 illustrates an example control method for any of the example blind systems.

### DETAILED DESCRIPTION OF EXAMPLE EMBODIMENTS

This application includes modifications and additional alternatives to the bullet proof blinds disclosed in U.S. patent application Ser. No. 14/476,206 filed on Sep. 3, 2014, and U.S. patent application Ser. No. 15/050,639 filed on Feb. 23, 2016, both incorporated herein by reference and substantially reproduced herein below.

This application includes modifications and additional alternatives to the bullet proof blinds disclosed in U.S. patent application Ser. No. 16/215,162, filed on Dec. 10, 2018, and incorporated herein by reference and substantially reproduced herein below.

This application also includes modifications to PCT application serial number PCT/US22/22860 filed on Mar. 31, 2022, which includes methods of producing the materials that can be used to produce the anti-ballistic blinds described in the above and below referenced patents and patent applications and described herein.

There are various proposals for improving ballistic protection of individuals and interior spaces in buildings and vehicles as discussed in the related patent applications listed at the top of this application. The inventor has discovered that a problem with many current solutions to these problems is that the protection devices don't absorb much of the energy that is contained in the ballistic projectiles, such as shrapnel or bullets that have been fired. The inventor has determined that one solution to this problem is to allow the protective device, such as a screen, panel, shroud, blind, or other barrier to hang freely, perhaps in a weighted manner, which allows the barrier to flex, vibrate, flow, sway and otherwise move in response to receiving the projectile, thereby dissipating some of the energy from the projectile that otherwise would remain as kinetic energy. This reduces the amount of damage and potential penetration of the projective with respect to a given amount of projection.

As shown in U.S. patent application Ser. No. 16/215,162 and its related parents, all incorporated herein by reference, various deployable barriers using non-metallic anti-ballistic materials can be formed for use as window blinds and similar barriers that might be provided at various locations in buildings. Use in windows, doorways, hallways, and other interior locations as a deployable barrier that is stowed when not needed provides a way to protect various interior spaces within buildings. Furthermore, barriers can be provided within vehicles in either deployable or fixed manners (or both). Deployable barriers might be used to protect vehicle windows, doorways, hatches, and other access points, whereas permanently deployed barriers could be provided within vehicle voids such as in doors, body panels, and other locations.

Of particular interest for at least some embodiments are barriers that are not fixed on their sides and bottoms, but that may include weights to increase their overall mass. Such barriers are free to flex and move in response to receiving a ballistic projectile, thereby converting at least a portion of the kinetic energy of the projectile into kinetic and heat energy in the barrier distributed across the entire surface area of the barrier. Allowing this free motion actually increases the effectiveness of the barrier by reducing the penetration energy of the projectile, thereby effectively improving the ability of the barrier to protect the desired person and/or interior region.

Of additional interest for at least some other embodiments are barriers that are still designed to flex and move in interior portions, but that are fixed on their sides and/or bottoms (i.e., fixed around a perimeter or portion thereof) in order to add additional stability and strength, such as to prevent a person or large object from entering a protected region. Such barriers are still free to flex and move in response to receiving a ballistic projectile in at least portion of their surface area, thereby converting at least a portion of the kinetic energy of the projectile into kinetic and heat energy in the barrier distributed across the entire surface area of the barrier. However, along with a fixed top, the fixed sides and/or bottom prevent individuals or objects from bypassing or pushing aside the barrier to get into the protected region. Hence, only the perimeter, or a portion of the perimeter, is fixed and secured, whereas an interior portion of the barrier is free to flex, vibrate, and otherwise kinetically absorb the energy of a ballistic projectile impinging on the barrier.

This application describes innovations that permit the efficient mass production of a variety of different laminated flexible anti-ballistic materials for use in manufacturing the flexible anti-ballistic laminates used in various anti-ballistic products, such as the bullet proof systems disclosed in U.S. patent application Ser. No. 14/476,206 filed on Sep. 3, 2014, and U.S. patent application Ser. No. 15/050,639 filed on Feb. 23, 2016, and the bullet proof blinds disclosed in U.S. patent application Ser. No. 16/215,162, filed on Dec. 10, 2018, and the barrier systems disclosed in U.S. patent application Ser. No. 17/006,442 filed on Aug. 28, 2020, and the mobile protection systems disclosed in PCT/US22/12537 filed on Jan. 14, 2022, and all incorporated herein by reference.

This application also describes improvements to the processes and products described in U.S. patent application Ser. No. 14/985,897 (Pub. No. US20170191803A1) filed on Dec. 31, 2015 (hereinafter '897), and U.S. patent application Ser. No. 14/070,007 (Pub. No. US 2015/0122815 A1) Filed on Nov. 1, 2013 (hereinafter '007), all incorporated herein by reference.

Generally, an example manufacturing method is to create laminated material sheets in large quantities of substantial width (e.g., 3, 4, 5, 6, 7, 8, 8 10 or more feet or fractions thereof) and long lengths (dozens, scores, hundreds, or thousands of feet) comprised of individual sheet layers of flexible, anti-ballistic material that may contain woven or unwoven fibers (such as fibers comprised of lightweight anti-ballistic materials described herein), or otherwise arranged in individual thin sheets comprised of fibers of a light-weight, anti-ballistic material, such as Kevlar (or other aramid fibers that may include poly-para-phenylene terephthalamide), Lexan, Tensylon, Dyneema (ultra-high molecular weight polyethylene (UHMwPE)), Twaron, other polyethylene, boron treated cloth, boron screens, polycarbonate, fiberglass (e.g., ArmorCore), carbon structures such as graphene, DLC, nanotubes, and other lightweight fibrous anti-ballistic materials. Flexible sheets that can be used might also be comprised of thin sheets of solid (non-woven or even non-fibrous) materials (sufficiently thin to be flexible and rollable), or screens of material. Such sheets can be thin, like foil, paper, or cloth, or thicker, like thin or thick cardboards, or even as thick as various plywoods, for example. Woven sheets can be twill weave or plain weave woven fabrics, and/or can be woven using different fibers, such as an anti-ballistic fiber and a carbon fiber, for example. Unwoven sheets can be mats of fibers resulting in sheets of various thicknesses and/or densities.

Layers of certain materials may utilize spacers or other items to allow the laminate to properly be configured into a roll. For example, Dyneema layers may need to slide a bit in relation to other layers to allow for proper rolling of the laminate. Certain types of layers, such as of a slippery material, may act as a “spacer” to allow Dyneema or similar layers slip or slide a bit relative to each other to be more easily rolled.

These sheet materials, which may be manufactured in-house or obtained from the marketplace, are formed from woven or unwoven cloth-like sheets of fabric or other fiber-based sheets of material through processes known in the art into long rolls of substantial width (e.g., 2 ft, 3 ft, 4 ft, to over 8 ft wide, or 45″, 53″, 62″ wide, for example) that can be fed into a laminating process (as described herein) to form laminates comprised of multiple layers of the material to form a wide, flexible, multi-layered anti-ballistic laminate that can be rolled or otherwise transported or fed for use in subsequent manufacturing into the desired end products. Silica powders or grains might be added to the sheets, whether woven or non-woven, to provide improved properties.

The sheets can be comprised from woven yarns, threads, or fibers to form knitted or weaved cloth-like material, or fibers can be arranged in a matted sheet of short or long fibers, like fiber-glass insulation or felt. Longer fibers and/or weaving may form more durable and less shedable sheets, but shorter fibers formed into a matt may be more economical to use.

Multi-layer graphene sheets can also be utilized for additional anti-ballistic properties. The graphene acts like a stretchy membrane, distributing the bullets energy over a large area, providing tensile strength, with stiff, strong, and elastic features provided simultaneously. Carbon nanotubes or other types of carbon fibers can be utilized as material to be added alone, or in combination with other materials described above, to add strength or other desirable properties. In some cases, the carbon may comprise half or more of the material in the sheet, or less than half. The carbon nanotubes (or other carbon fibers) are light, flexible, strong, and thermally-stable, and in a bullet proof (anti-ballistic) structure, millions of these nanotubes (or other fibers) come together to form carbon nanofibers which are woven together to create lightweight material sheets. The resulting carbon nanofibers are extremely efficient at absorbing energy, making them beneficial for bullet proof and bomb proof (shrapnel proof) materials and sheets and laminates. Other types of carbon fibers can similarly be used for strength or to provide other or additional beneficial properties. Sheets of metal foils might also be used to add strength or other properties, such as EMF protection or heat or EMF reflections.

These individual sheets might be comprised of woven yarns of material (threads, fibers, etc.), or individual fibers formed into a matt or other structure where the fibers hold together into a flat, flexible sheet by cross-interconnecting fibers or using adhesives or other bonding agents, or by pressing the fibers into a compressed sheet. Such sheets might be sprayed with, or dipped in or passed through, a liquid or powdered adhesive or plastic which, when set (suing heat or drying or other chemical process), may keep the fibers cohesive and connected together and not be loose and shedding. For example, the sheets might be sprayed using the same material comprising the fibers in liquid form, or dissolved in a carrier that evaporates, or multi-part portions that chemically react like an epoxy, or sprayed with an adhesive such as glue to bind the fibers together. The sheets might be pressed using a roller to compress the fibers, and they might be heated sufficiently such as by using heated rollers, arcs, hot air, to set the material and/or bond the fibers together.

Note that different layers of material can be chosen for combination to provide different properties. For example, mixing Kevlar and Dyneema together (e.g., in alternating layers or putting fire resistant layers as outer layers with Dyneema as inner layers) provides the advantage of both materials, including Dyneema's flexible bonding properties, and Kevlar's fire resistance. Coatings can be provided (such as by spraying or dipping) to improve fire resistance, such as coating with a fire retardant paint or coating, or using fire retardant adhesives (e.g., FLEXCON® V-59FR Non-Halogenated Flame-Retardant Adhesive), for example, to reduce the combustibility of materials like Dyneema. Layers of fire blocking material can be utilized in the laminate to improve fire resistance.

Adhesives can include epoxy, cyano-acrylate, polyamide, or modified phenolic adhesive or thermal curing agents. Bonding may be done in an atmospherically controlled environment. For example, Kevlar-to-Kevlar bonding may require only a relative humidity of 55%, whereas Kevlar-to-non-nylon materials may require a RH factor of 8.

The laminated layers are desired to be formed into a cohesive structure by bonding them together in a manner that does not easily separate back into individual sheets. This can use the processes disclosed in the '007 and '897 references, and might also including: gluing; stitching (including one or more of lockstitch, chain stitch, straight stitch, zigzag stitch, running stitch, back stitch, satin stitch); spot welding; arc welding; RF welding; flame lamination; riveting (or use of other fasteners); hook and loop fastening; quilting; taping; etc.

For example, a hot thin bar could be pressed into the laminate at regular intervals to weld thin strips of the material together at those regular intervals along its length, or even in a quilting pattern. Bonding based on mechanical, chemical, thermal, or hydrogen bonding can be used. Glues can be sprayed on or the material may be dipped or otherwise passed through a glue bath for subsequent curing by heat or chemical means.

Bonding could be accomplished using fasteners, such as powder coated staples or snaps or clamps, for example. Individual laminates could be provided with snaps or Velcro or other types of fasteners or bonding such as stitching or spot welding or gluing to allow additional layers of laminates to be stacked together to form further laminates of laminates. Plastic or metal rivets can be punched into the laminate. Combinations of these bonding approaches can be used.

Bonding approaches might be utilized that allow for the bond to break in situations of stress to allow the laminate to better absorb the energy of an impinging ballistic or other object. For example, threads used for stitching might be made breakable during certain high stress levels, or a Velcro-like connector may be designed to break away during high stress levels. By breaking such bonds may become a sacrifice to absorb kinetic energy, and/or allow for more relative motion between laminate layers to further absorb energy.

Alternatively, strong threads might be utilized for adding structural strength. Strips of strong materials or screens may be used to add additional structural strength and other desirable qualities.

Generally, the desired number of layers, from two to half a dozen to a dozen to more, to 16 layers of ballistic sheets, or more, are rolled out and stacked and fixed (bonded) together using the desired method such as those described above or below. Or a few sheets might be formed into a laminate, and then those laminates used to form further laminates downstream to increase the thickness and provide desired properties. For example, two or three-layer laminates can be formed that can then be combined to form 2, 6, 8, 10, or more layer laminates using one or more downstream laminating stations. Any number of laminating stations can be utilized, as desired, for increasing thickness, and by repeating stations, economies of scale are provided by repeating similar stations serially.

Laminates of various numbers and types of layers can be provided as alternatives for use various types of products. For example, fewer layers may be used in a rollable blind where flexibility and rollability is important whereas more layers might be used in a fence or permanent structure where more protection is desired and repeated rolling is not necessary.

Furthermore, the initial laminates may use one method of combining the layers together while the downstream lamination methods use a different method or different layers. For example, the initial laminate might be bonded using a glue (or stitching), with the subsequent laminations bonding the glued laminate using stitching (or gluing), for example. Some stations may bond woven layers, while other stations bond unwoven layers. Further, some stations might add metallic screens, structural layers, decorative layers, or adhesive layers, for example (especially such as external decorative layers). By placing these stations serially, any desired composition of laminates can be provided, as desired. Hence, a laminate having 3 or more layers of anti-ballistic sheets of fabric (or other flexible sheets) can be provided with outer layers of decorative or structural or fire resistive layers, for example. Or structural and/or fire resistive layers may be used alternately in the laminate.

Furthermore, it may be desired that different sheets of different material are used for different locations in the laminate, or at the same locations. For example, the inner layers of the laminate might be comprised of one or more sheets of mats of loose fibers, whereas outer layers are comprised of sheets of woven material. In this manner, the outer sheets, which will naturally be less likely to shed fibers, can contain the more likely to shed fibers of the inner layers. In this manner, cost savings may be obtained by using fewer layers of woven material and more layers of matted material while achieving the benefits both. In such an approach, the method of bonding the laminates may depend on the type of sheets used in the laminates. For example, it may be more effective to glue matted unwoven sheets together, while woven sheets are stitched or spot welded, for example.

Layers of fire retardant materials can also be interspersed between layers of anti-ballistic materials and/or layers of strengthening materials to achieve the desired properties. It may be beneficial to put combustible layers in a center and cover them with fire resistant layers as outer layers. Or such layers can be alternated. Furthermore, one or more layers, or the entire laminate, might be saturated with or provided with a layer of an anti-ballistic or fireproof gel for further anti-ballistic properties, fire retardant properties, adhesive properties, or any combination of these properties or other properties.

Such approaches can lead to a number of embodiments for creating different types of structures and manufacturing approaches. For example, a three layer laminate might be comprised of one or more inner, matted sheet(s) formed at one laminating station, and one or more outer, woven sheet(s), all stitched or glued together at a subsequent processing station. Or all three layers may be of the same material processed at one station, or two at one station and the third at another station. In this way, processing stations can be placed serially to achieve many different desired layers using various different bonding methods.

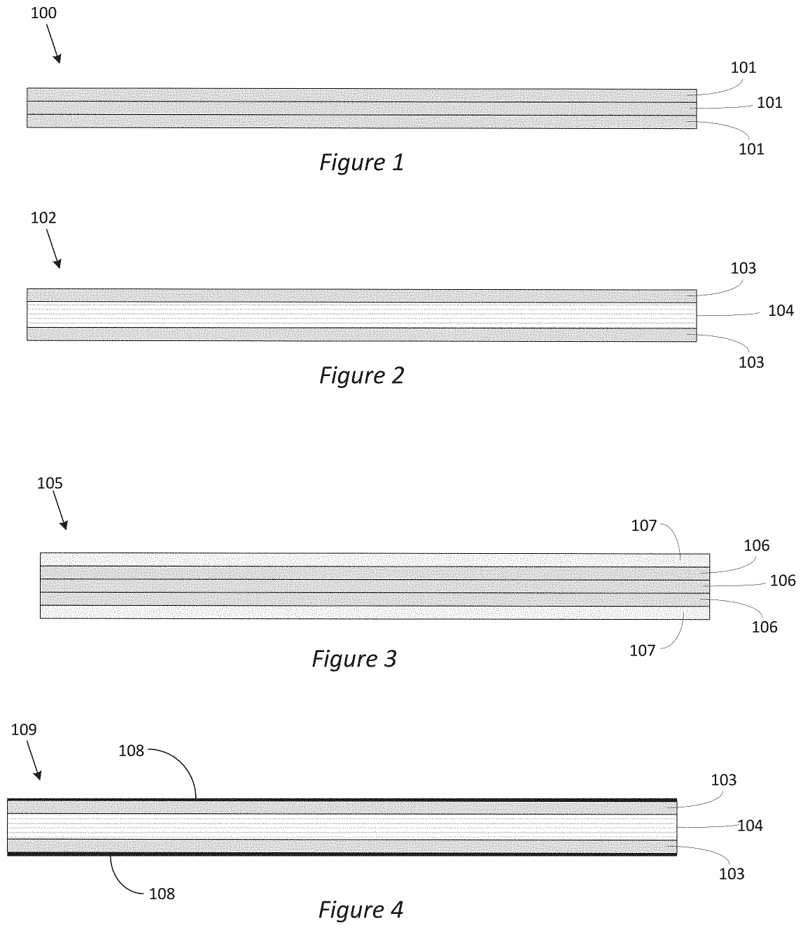

For example, FIG. 1 shows an example laminate 100 having three layers 101 of the same material bonded together using any of the methods disclosed herein. FIG. 6 shows a view of a laminate 115, such as shown in FIG. 1 or another embodiment, that is bonded using stitching 116 provided horizontally across the laminate in a regular pattern. The distance between stitches can vary according to need, but closer stitching can help prevent fraying and other problems when cutting the laminate. Stitching in a quilt pattern can improve such features as well by adding vertical stitching as well.

The stitching process itself can be used to provide desired properties. For example, the stitching might provide structural strength, or have energy absorbing properties to aid in the integrity and anti-ballistic properties of the resulting laminate. Various different stitches could be used, such as chain stitching that is easier to implement and allows material to stretch and move easier, or the more secure lock stitch that is more difficult to utilize (requiring a bobbin), but is less likely to unravel and provides additional benefits. Threads for stitching might be chosen for structural strength, such as by using polymer or aramid threads, or they might be chosen to have break-away capability for increasing energy absorption capability. Metallic or cotton or nylon or other types of threads can also be used.

Woven layers might be bonded using glue, spread on entire sheets or as lines or other partial coverage. The glue might be sprayed or laid on, and then cured using a heat treating or chemical process, or by spraying with water (prior to, or subsequent to, applying the glue), or the glue may be self-drying (such as by exposure to oxygen or evaporation of a substrate). A powdered glue or polymer might be used that melts when heated to flow into the layers and form a permanent bond.

Alternatively, double or triple layer matted, unwoven sheets might form one laminate all glued, pressed, sewed, or spot welded together, that is later processed to add an outer layer on one or both sides of woven sheets that are stitch bonded or glued to the adjacent laminate, leading to a 2, 3, 4, 5 or more layer laminates, for example. Sixteen layers is a desirable laminate amount for some purposes. And by using more than one method of bonding, the benefits of those different methods can be combined, improving the final result.

Furthermore, layers might be provided to add additional desired properties. For example, layers, strips, threads, etc. that add strength could be provided. Or fireproof layers. Or insulating layers. Or decorative layers (especially as one or both outer layers). Or bonding layers. Or anti-ballistic layers. Sheets having different properties can be combined to offer unique features. For example, mixing and matching sheets using different types of anti-ballistic materials can be chosen to offer strength, fireproofing, flexibility, and other desired properties.

Outer layers that are slippery, such as might be coated with polymer coatings like Teflon or other slippery surfaces, may be used to provide desired features, such as ease of deformation or turning of bullets, and slippery motions. Reflective outer layers (such as a polished metallic foil) may be useful for heat protection. Rubber or other resilient materials may be used for outer layers or inner layers to add spring or return properties to the material. Layers may be used that hold their shape once formed into that shape, such as a metallic layer, for example.

Layers that react chemically or physically to a ballistic impact can be utilized to transform kinetic energy into feeding a chemical reaction, or layers might self-destruct to absorb energy. Materials that momentarily melt or deform can be used to absorb kinetic energy.

Metal screens might be used to add stiffness and further anti-ballistic properties, where flexibility is less important. Or metal screens that are sufficient thin can still allow for flexibility. Metals such as steel alloys (e.g., stainless steel, carbon steel, etc.), copper, bronze or brass, aluminum, or other types of metal or alloys thereof can be utilized. Metal threads might be used for strength. Metal powders might be used to achieve desired properties.

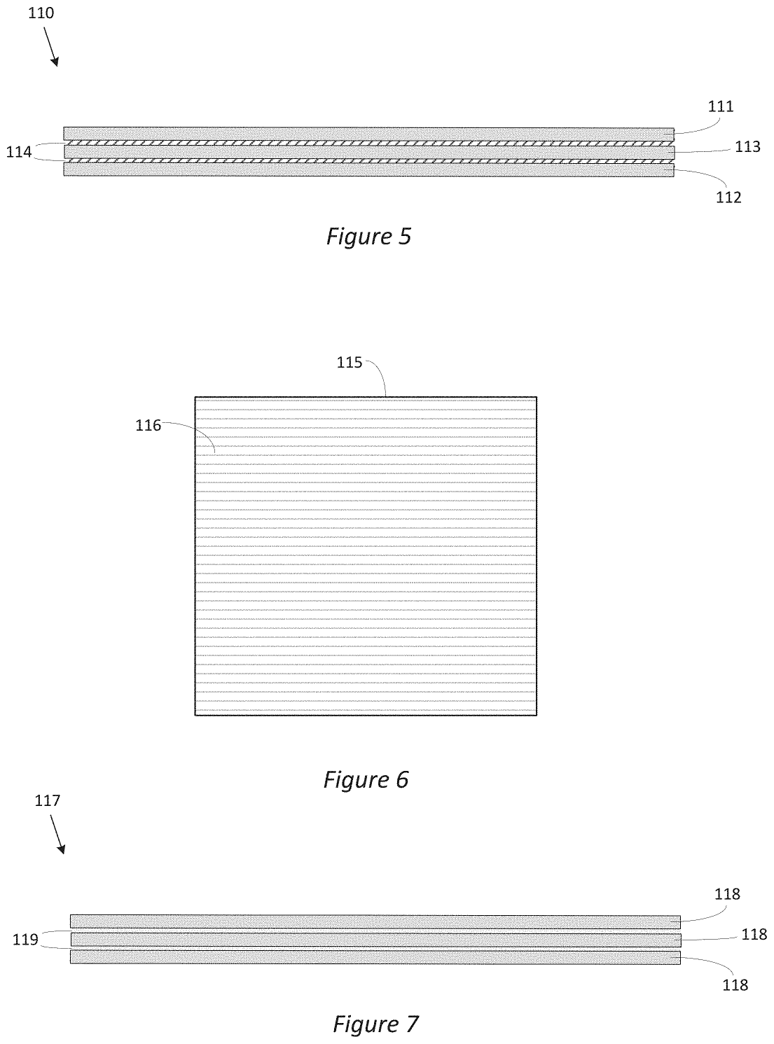

For example, FIG. 5 shows a laminate 110 having anti-ballistic layers 111, 112, and 113 (which may be different types of layers—e.g., woven and unwoven, or the same types of layers but of different thicknesses, or the same layers, any as described herein), with metallic screens 114 provided between the layers for strength and further anti-ballistic properties. Note that if the screens 114 are made sufficiently thin, the laminate 110 will be flexible, but the screen might be made sufficiently thick to help the laminate hold its shape when bent, curved, or folded. Such a laminate can be fashioned into various configurations of different geometric shapes to make complex objects or to fit into complex locations, such as corners, etc. Thin foils or small gauge screens could be used to add EMI protection.

Or some layers might be comprised of a fibrous or solid sheet of glue or resin material that melts and bonds adjacent layers when heated and melted. Such a material may flow into the adjacent layers, creating a strong bond without the use of any liquid adhesives. Hence, the laminating and bonding process might include placing an inner layer of glue sheet (solid or fibrous) between two outer layers of anti-ballistic sheets, then running the stack through heated rollers or an oven to melt the inner layer to bond the two outer layers together. Or glue might be sprayed or spread on various laminate layers with the layers then stacked on top of each other.

FIG. 7 shows an example laminate 117 having anti-ballistic layers 118 bonded using a glue or resin layer or gel layer 119 provided between them, which might also provide useful properties, such as fireproofing (using a fireproof adhesive), structural strength, or even additional anti-ballistic properties. Use of a glue can be an air-dry glue, or a two-part glue such as an epoxy, or a heat activated glue, or a resin, for example. A gel, which may remain a gel in the finished product or may be solidified, may provide additional anti-ballistic properties, fire resistance, or other desirable features. These layers 119 might be laid on (as a sheet of material or strips of material) or sprayed on or spread on during the bonding process and could be heat activated or chemical activated (such as by exposure to air/oxygen).

Furthermore, the outer layers might be made decorative or paintable, or in some other manner that leads to flexibility in the esthetics of the end product. In some cases, the final, outer layers may be solely for decorative purposes, with no anti-ballistic properties. For example, FIG. 3 shows an example laminate having inner layer(s) 106 of anti-ballistic material bonded together, with outer layers 107 bonded to the inner bonded layers which may be decorative for aesthetic reasons.

Another approach is to use one thick layer of matted, unwoven fibrous sheets placed between two outer layers of thinner sheets of woven fabric or other solid material. Then, if the layers are quilted or stitched or glued together, the mat fibers will mostly be locked into place between the woven or solid layers, allowing flexibility and material volume at lower cost. Note that these laminates can be processed between rollers to compress them and reduce the overall volume (thickness) of the laminate. Alternatively, higher volume might be desired in some applications, in which case the mat sheets are kept thick and airy and not tightly wound on finishing rolls. For example, thick, airy sheets can be used for forming blankets that insulate as well as cover and protect the contents from ballistic attack. Protective products providing insulation can be used to create tents, clothing, rugs, drapery, or other protective products in a wide variety of forms.

For example, FIG. 2 shows an example laminate 102 having a thicker, inner layer 104 comprised of, for example, matted fibers surrounded by two outer layers 103 of woven material, or a laminated material comprising a plurality of layers of woven or unwoven material. Alternatively, thicker woven layers might be adjacent to inner woven layers between them (of the same, or different, materials). Or FIG. 2 might show an inner laminated material with opposing structural or decorative layers 103 on one or both outer sides. Similarly, FIG. 4 shows the laminate 102 of FIG. 2 adding two outer layers 108 for structural or decorative purposes. Hence, three different types of layers could be utilized, such as an unwoven mat 104, woven layers 103, and decorative or structural layers 108. When desired, only one outer layers 108 might be used, or one layer might be decorative and the other structural. Or layer 104 may be comprised of a laminate of a plurality of woven or unwoven layers or a combination thereof.

The laminate might be made stretchable by using an approach like above, where the inner layers are more fibrous and looser formed, with the outer layers being stretchable, such as a thin rubber material that may be a rubber with embedded anti-ballistic fibers. Chain stitching can aid in stretchability. Alternatively such a laminate might be stitched together using a rubber or other stretchable thread acting like a bungee cord.

Note that these various laminate features described above can be mixed and matched to provide desired features. Any of the types of starting sheets of material, whether comprised of matted, unwoven fibers, woven yarns, felts, screens, glues or other bonding agents, decorative layers, structural layers, etc. can be mixed and matched to provide the desired features for a given application. Bonding methods can be combined in order to provide additional structural advantages, where desired.

The laminate examples discussed above, along with other variations, can be efficiently manufactured in volume in order to meet market demands. In particular, the provision of strong, anti-ballistic properties for adding to various products and structures is desirable.

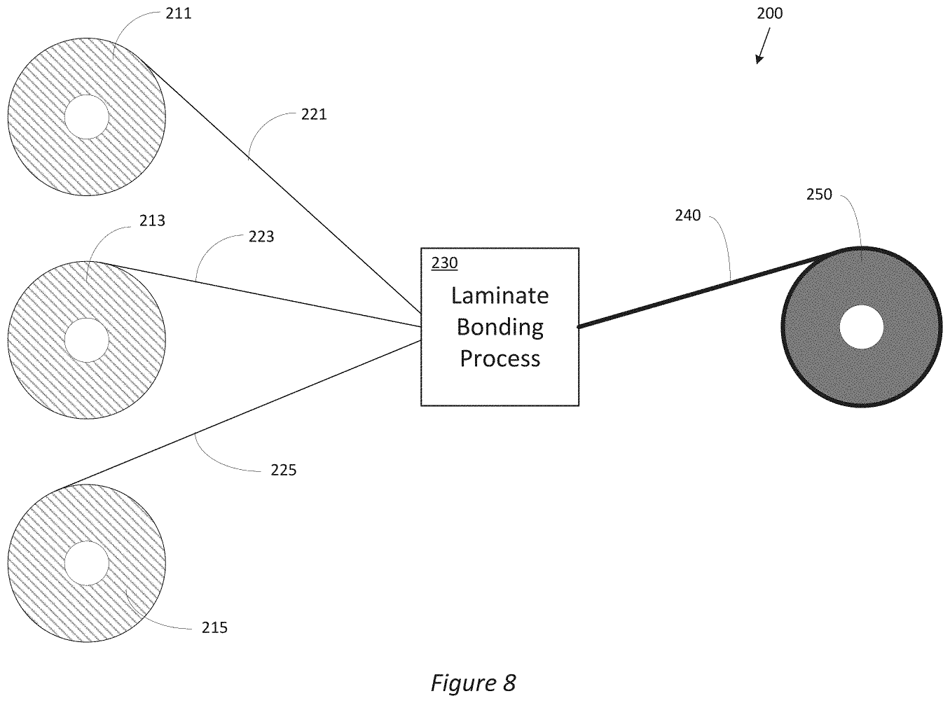

FIG. 8 shows an example manufacturing process 200 that can be used with many of the disclosed embodiments. Multiple rolls of material (e.g., continuous sheets or laminates), 211, 213, 215 (three are shown in the example but different numbers of rolls can be utilized) are provided each having material 221, 223, 225, respectively, rolled thereon. These materials 221, 223, 225, may all be comprised of the same material, or of different materials, as desired and described herein. For example, woven or unwoven (or both) fabrics of anti-ballistic material might be used, or one may be a bonding agent such as a glue or resin mat, for example.

The materials 221, 223, 225 are continuously fed into a Laminate Bonding Process 230 that bonds the materials 221, 223, 225, into layers of the resulting laminate 240 that are bonded together, preventing separation. The bonding process could include heating, spot welding, gluing, stitching, the processes disclosed in the '007 or '897 references, or any other process described herein or known in the art to bond laminates or other sheets of materials (such as woven and unwove materials, foils, thin films, etc.), or any combination thereof. The bonded laminate 240 can then be wound onto a roll 250 for transport to another location, for use in manufacturing products, or for further processing at another location, or the laminate 240 could be fed directly into another process (without rolling) for further processing and/or making into finished components or finished goods in a continuous process.

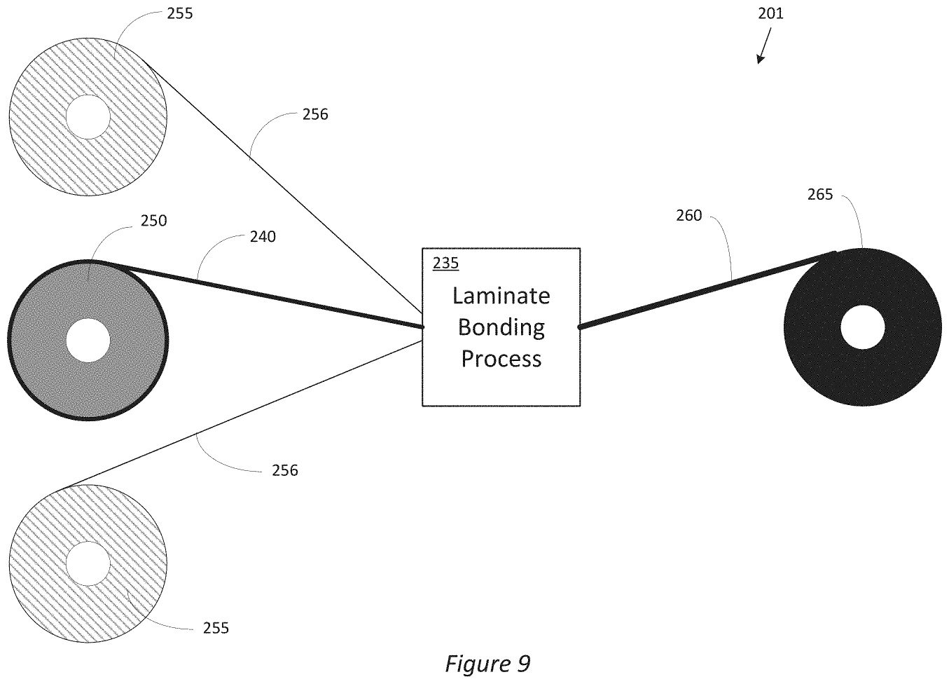

FIG. 9 shows an example further downstream process 201 that uses the laminate 240, along with additional layer materials 256 (e.g., a continuous sheet) that are continuous fed to produce a further laminate 260. For example, the layer materials 256 may be decorative material that is to be bonded with the laminate 240 for decorative purposes, or it might be structural material, or additional sheets of material having desired properties such as anti-ballistic properties. For example, the laminate 240 might be comprised of a matted, unwoven material comprised of anti-ballistic fibers that are glued together, whereas material 256 is of a woven material that will encapsulate the matted laminate 240 using for example, glue or stitching to bond them together. Note that the roll 250 might be avoided if the laminate 240 is fed directly into the station 235.

Alternatively, the laminate 240 might be replaced with a single layer of matted, unwoven fibers formed into a sheet that is then encapsulated by woven, low shed material 256, as described hereinabove. Or material 256 may be a prior formed laminate.

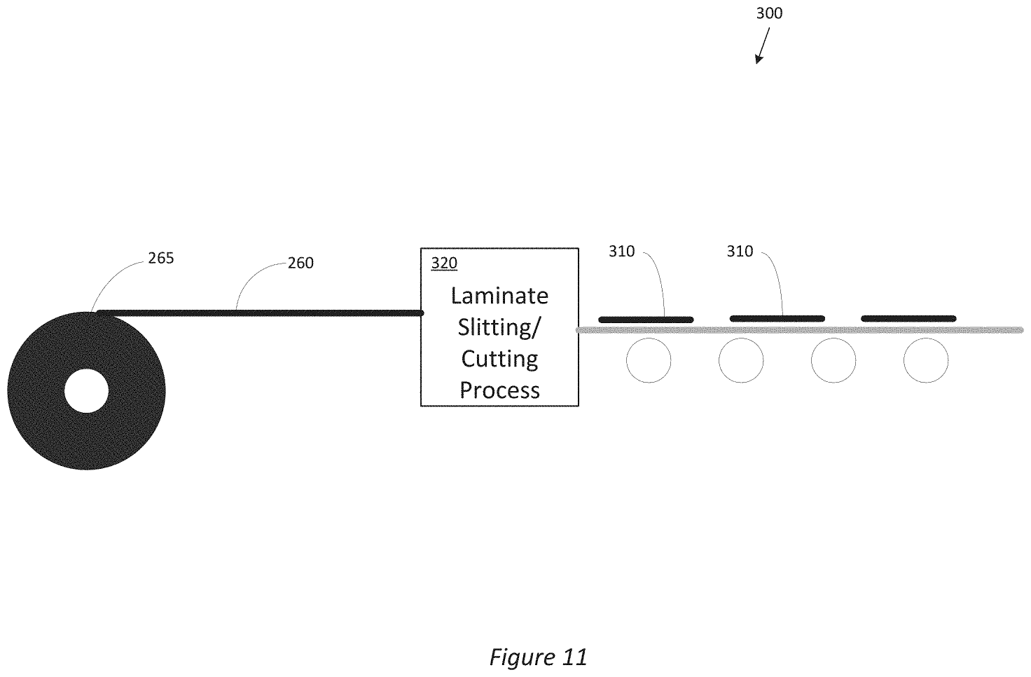

These layers 240, 256 are then bonded together into laminate 260 by the Laminate Bonding Process 235, which might include any of the bonding methods discussed herein, such as using stitching, adhesive, welding, etc. Laminate 260 can then be wound onto a roll 265, or provided for further processing such as described in FIG. 11, which shows a finish process 300 with laminate 260 being processed by a slitting/cutting process 320 into individual sheets or panels 310. Other types of processing can also be provided, as desired, including processing into finished goods such as anti-ballistic doors or window blinds, for example.

By utilizing the above disclosed processes in series, laminates of any desired number layers having any desired combination of composition can be manufactured. For example, a 16 layer laminate can be made using four stations creating four layer laminates all feeding into an additional station to create the 16 layer laminate. The 4 layer stations may use one type of bonding (e.g., glue) and the 16 layer station a different type of bonding (e.g., stitching), for example. If desired, the 16 layer laminate may then be fed into an additional station for adding one or two decorative outer layer(s), for example. Of course, numbers other than 4 or 16 can be utilized, as desired, to create any numbers of layers at any stage of the manufacturing process.

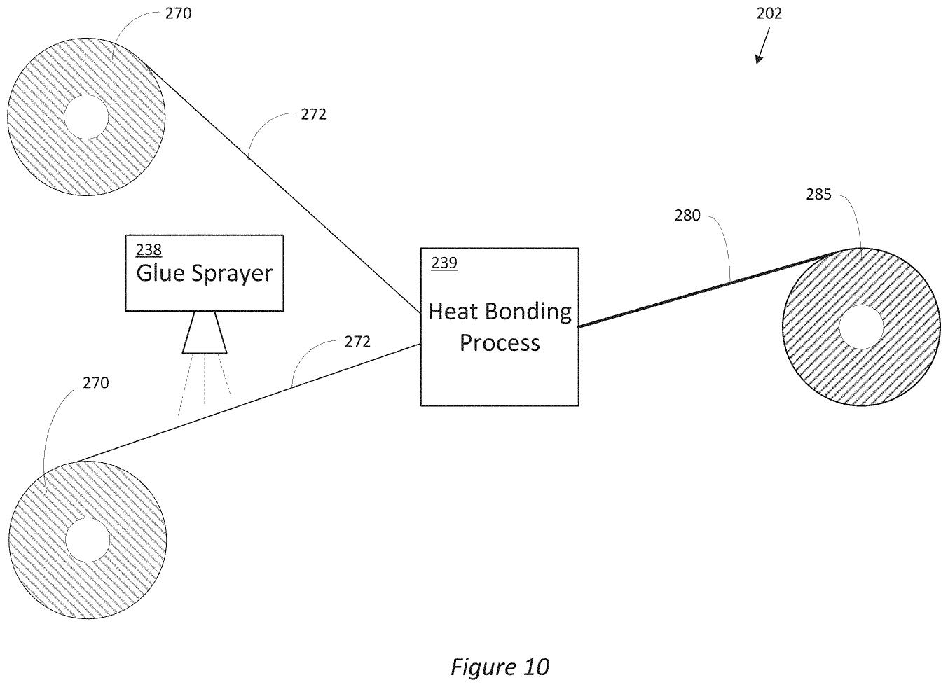

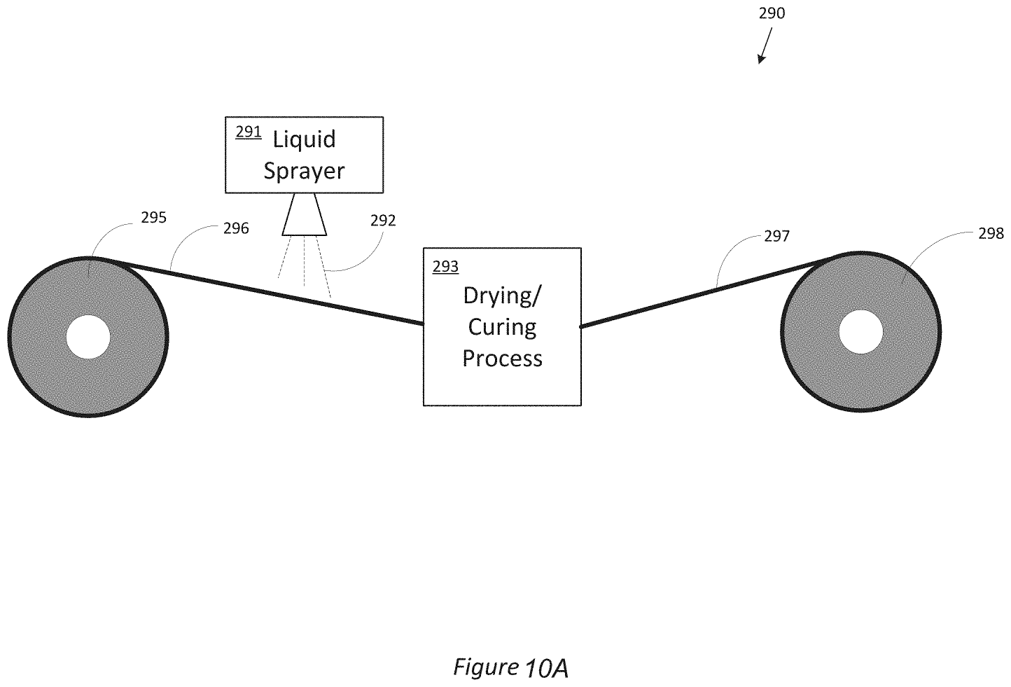

FIG. 10 shows an additional method 202 of manufacturing a desired laminate 280 by continuously feeding two or more continuous sheets of material 272 from rolls 270 past a glue sprayer 238 that sprays a glue (or some other bonding agent) onto some of the laminate layers 272 such that each adjacent layer has at least one surface covered in glue. The sheets 272 are then put through a Heat (or chemical or other) Bonding Process 239 that cures the adhesive, such as by heating, or blowing drying air, or spraying a chemical, or some other process to cure the adhesive, leading to a bonded laminate 280 that can be rolled onto roll 285, if desired.

As an alternative, the sprayer 238 may spray a fire resistant substance, or it might be sprayed on outer surfaces of the laminate sheets rather than on inner surfaces to provide structural strength, fire-resistant, decorative, reflective (light or heat), and/or other desirable features. For example, FIG. 10A shows a process 290 for adding a decorative outer layer using a sprayer 291 to spray a liquid or gel substance 292, such as a paint, sealant, glitter, or other substance onto an outer surface of a laminate 296 being fed from feed roll 295 into a drying or curing process 293 to cure or dry the substance 292 for outputting a laminate 297 having the outer surface layer thereon being rolled onto roll 298. Such a process could be used to provide an outer layer for a decorative outer surface on the laminate, or to seal the laminate surface, or provide a textured surface, etc.

Additional processes can be utilized. For example, the process of FIG. 8 might use two outer layers of materials (221, 225) with an inner layer of bonding material (223) that is then heat processed to form a dual layer laminated with an inner layer of adhesive bonding the outer layers together. Any of the above bonding processes can be mixed or matched to obtain the desired features of the final laminate, and laminated layers can be further laminated with other or similar layers as desired, to obtain a final laminate of any desired thickness and any desired number of layers.

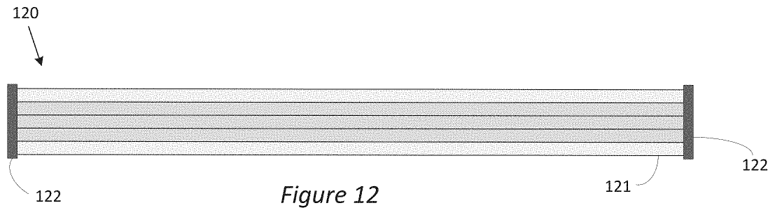

FIG. 12 shows a laminate 120 using any of the above laminates disclosed above, but having an additional manufacturing step of providing edge caps 122 to edges of the laminate 121. This can be particularly useful when the laminate 121 is comprised of sheets of a woven or unwoven fabric that may display frayed edges (such as due to fiber ends due to cutting or the result of the manufacturing process). These edge caps 122 may be comprised of a glue layer provided on the edges, solidified plastic provided on the edges, a sprayed on material, or may be created by melting and solidifying an edge of the original laminate.

Alternatively, the ends of the edge may have one or more outer sheets (such as by providing a wider sheet to have overlap) folded over and bonded to the opposite outer sheet (such as by gluing, stitching, spot welding, etc.) to seal the edge. The frayed edge of the folded sheet, if any, can be glued or otherwise fixed by some bonding process to the surface of the other outer sheet to seal the fray.

Hence, adding an additional step of providing such edge caps as described above to seal the edges would mitigate the problems that may occur with frayed edges, such as shedding or additional fraying.

One alternative process is running the laminate layers through a liquid bath to provide desired properties and to further prepare the layers, such as impregnating the individual or laminated layers for desirable properties. For example, boron baths can be used on any absorbent material, adhesive baths, or other liquid treatments to add desirable properties such as additional anti-ballistic properties, for example.

Note that the feeding process of continuously feeding sheets for processing could be varied to achieve desired properties. For example, feeding from the vertical or at an angle may allow excess adhesive or coatings to drip off. Yarns or threads could be coated or soaked to pre-treat them to obtain desired features.

FIG. 11 shows a slitting or cutting process that can be used to cut the laminate into lengths (and/or widths) of the desired size. The laminate 260 (such as from a roll 265 or directly from a previous station) can be fed into a slitting/cutting process 320 to cut the laminate into sections of a desired size. In cases where the laminate is too thick to roll onto a roll 265, it may be fed directly from a prior process forming the laminate 260.

The resulting sections 310 can then be used to create a finished product. For example, the sections 310 may be slats that can be used in venetian blinds, or sections for use in a fence or door, or longer sections to form drop down barriers like blinds, for example.

Further note that although the layers described hereinabove are mostly comprised of woven or unwoven sheets of fabrics using fibers, individual layers of the laminates might instead, or additionally, utilize thin sheets of solid material that can also be flexible, such as foils or solid, thin films of plastics or anti-ballistic materials, or even stiff materials. Some materials, such as Kevlar, might benefit by using an abrasion process on the surface(s) prior to performing adhesive or other bonding processes.

In a preferred embodiment, any of the above described laminates can be used to produce products that have anti-ballistic properties, and which might be certified to various standards of bullet-resistance and protection from shrapnel distributed by a bomb, for example. These laminates, comprised of any combination of the anti-ballistic materials described above can provide protection from bullets fired from handguns, rifles, shotguns, or other weapons. They can also provide protection against knife thrusts, or shrapnel resulting from explosions such as bombs or other weapons or explosive devices.

These laminates can be utilized in barriers of various designs to protect enclosed or external spaces, such as by use in fencing, blinds, mobile barriers, or other types of deployable barriers that can protect a space or region or people from ballistic objects. Furthermore, these barriers can be used in walls or doors to provide protection from penetration by ballistic objects, or even vehicles and/or persons or other objects that may threaten a space or people.

For example, the rolled sheets of finished laminate can be cut to desired lengths and/or widths to form sheets for rolling for use in blinds or other deployable barriers. Or sheets of laminates can be cut and used to create thicker and stiffer materials to form slats that might be used in fencing or venetian style blinds. Sheets of laminates can be used with doors or as part of the structure of doors for use in garages or other buildings to protect against vehicle entry.

The above products, which we can refer to as roll goods, can be used to manufacture various types of window blinds, door protectors, and other barriers, as described hereinbelow.

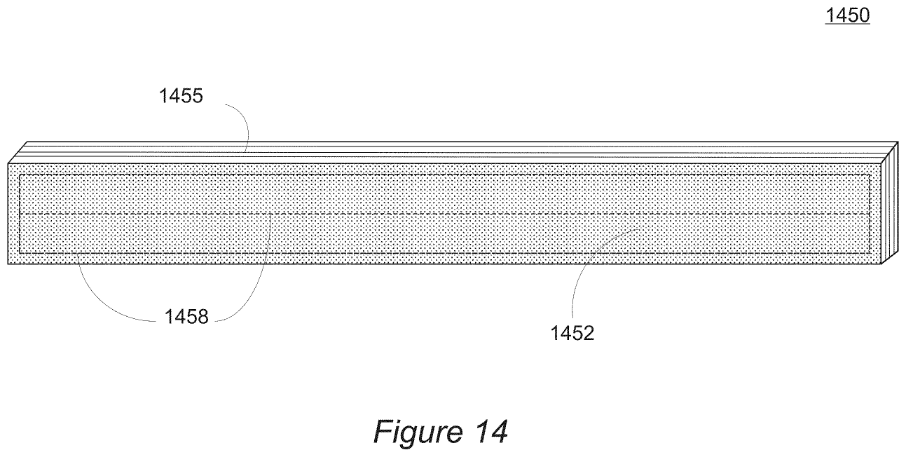

FIG. 23 shows a side view of a laminated material 1400 having ballistic layer (or plurality of layers) 1420 sandwiched between decorative layers 1410 and 1430. As an example, layers 1410, 1430 could be a single layer of fabric surrounding a ballistic panel as layer 1420. Or ballistic layer 1420 might comprise a ballistic fabric or laminate of fabric layers, making the entire slat of layers of fabric and/or sheets of material. Hence, part of the blind, such as louvers/slats, can be made in this laminated manner to provide both decorative and anti-ballistic features. The layers could be glued together, or bonded in some other manner, such as by heating them to weld them together or stitching (sewing) them together using a strong thread, as described for the embodiment shown in FIG. 14, discussed below. A lamination machine that binds the layers using heat can be used.

FIG. 14 shows an example slat or portion of a blind comprised of an anti-ballistic laminate 1450 having a plurality of layers of flexible, anti-ballistic material 1455 and a decorative top layer 1452 that are stitched (sewed) together using stitching 1458. An embodiment may use any number of layers of anti-ballistic material, which may be a woven cloth material or a thin sheet. For example, such a blind might use two, or more than two such layers. In a preferred embodiment, 12, 16, or 18 layers of level 3A bullet proof material, such as an antiballistic cloth material or thin sheets of material as discussed above can be stacked into a laminate that can be glued, heat welded, or stitched using a thread, such as nylon, polyester, Kevlar or Dyneema® threads, to secure the layers together. The top (and in some cases bottom as well) decorative layer 1452 can be comprised of a decorative cloth or sheet. A binding material or strip can be put around the outer edge of the sheets or slats for decorative purposes or for physical support and further binding. For large sheets of materials, stitching will be provided at periodic intervals (e.g., 0.75 inch spacing).

For example, 18 plies of woven Kevlar fabric such as a 600d Kevlar KM2 Plus, 24×24 square yarns per inch, plain weave construction, polyester stitching yarn, 75 denier textured yarn with a stitch pattern from a linear chain stitch (machine direction), 3.5 gage spacing or 0.75 inch spacing.

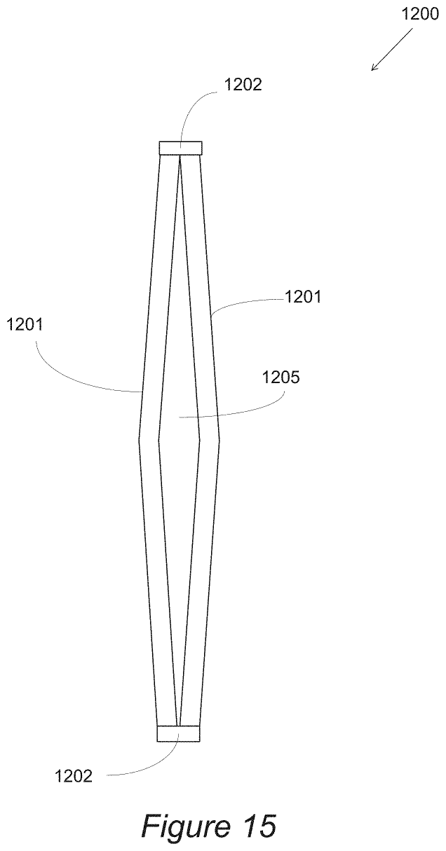

Sheets of material of the blinds, or individual slats, may have the individual fabric sheets bound by using a glue or substance around a perimeter of the sheets or a pair of edges to hold the sheets together, but let the layers remain unbound in an interior portion. FIG. 15 shows a side view of an example two-layer laminate 1200 with first and second fabric layer 1201 having only upper and lower edges 1202 bound with an edging material (such as stitching, bonding, edging, etc.) leaving an inner gap 1205 formed from the loose material. Of course, any number of layers can be used in the laminate rather than just 2. This approach could be designed to self-destruct in order to better absorb the energy of a projectile.

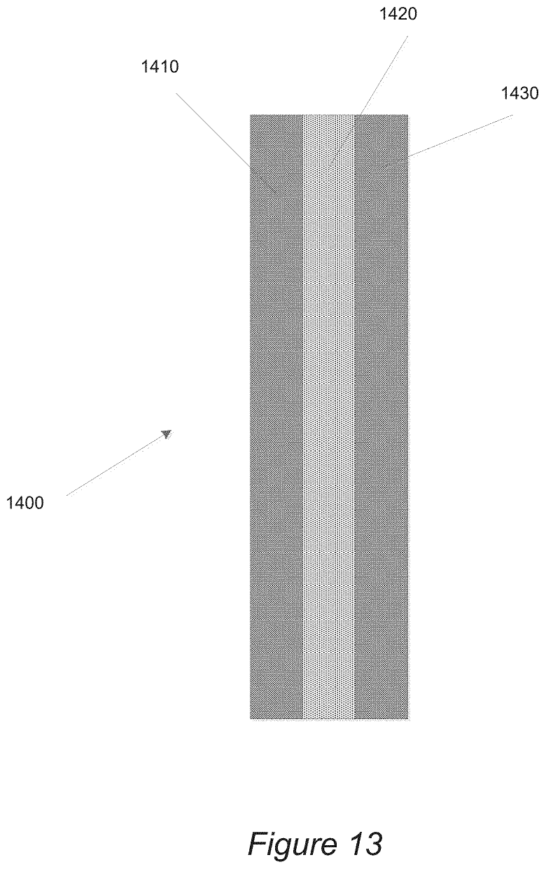

The laminated material of FIGS. 13-15 can be formed into slats to form venetian style blinds, or alternatively into sheets (e.g., by repeating the sewing pattern) to form solid blinds that can be used in homes or vehicles as barriers (e.g., blinds) as discussed herein.

Alternatively, tensylon slats can be used for the venetian style blinds. As an alternative, a thin layer of steel as a strike face can be provided on the slats to improve the anti-ballistic properties. Tensylon slats, with or without the steel surface layer, can slide in pockets on the kevlar fabric blinds to add further protection, such as in solid sheets that are rolled up when retracted and unrolled when deployed, as described hereinabove. Such blinds re flexible and lightweight, and could be designed to level 4 protection to stop rifle rounds.

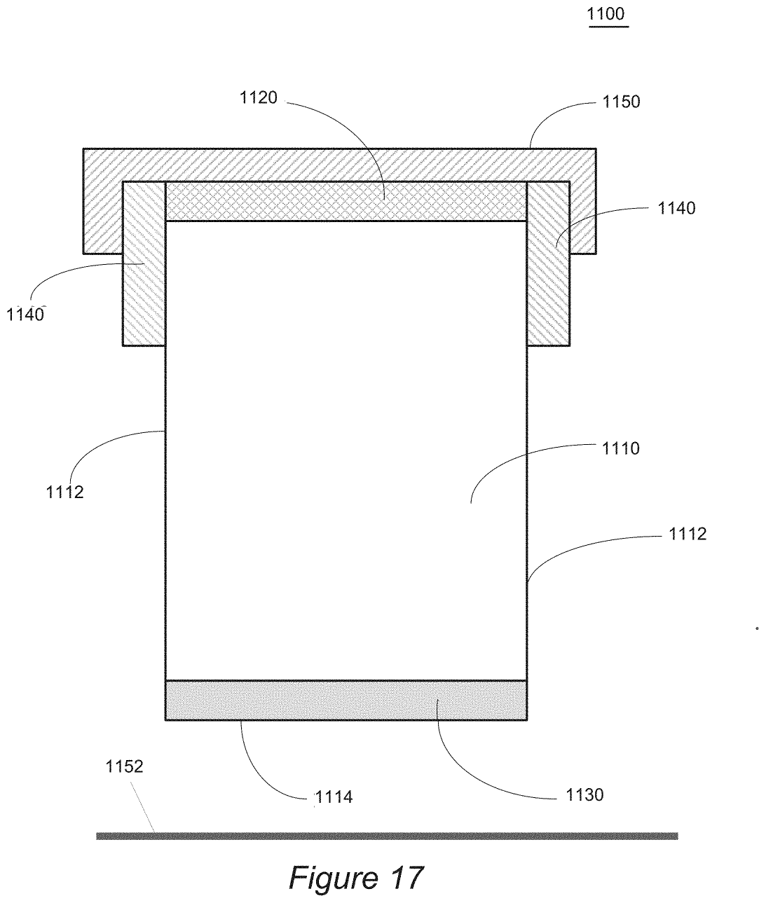

FIG. 17 shows a schematic of a basic general barrier design 1100 that can be used for many of these various barriers, including window blinds. The primary protective part is a barrier layer 1110 which in many of the example embodiments will be comprised of a laminate of a plurality of layers of flexible antiballistic material. FIG. 13 shows an example of such a laminate 1400 that can be used, with an inner layer 1420 that is also likely to be a laminate, and with optional outer layers 1410 and 1430 providing protection and/or decorative layers.

The inner layer 1420 can be comprised of a plurality of layers of anti-ballistic material that might include layers including one or more of: plastic, composites, wood, metal, fabric, fiberglass or any other suitable anti-ballistic material including, but not limited to, Kevlar® (which is a synthetic fiber of high tensile strength comprised of poly-para-phenylene terephthalamide) or Lexan® (which is a transparent polycarbonate of high impact strength) or Lucite® (which is a solid transparent plastic comprised of polymethyl methacrylate) or DuPont™ Tensylon® (which is an ultrahigh molecular weight polyethylene anti-ballistic material), or a boron treated cloth, or a plexiglass with anti-ballistic properties, for example, or any combination thereof. Anti-ballistic gel materials such as shear thickening fluids that may be transparent can be used to saturate a material or fill voids (some of these materials harden upon impact and might be comprised of non-Newtonian fluids that that thicken in response to force). Other materials or combinations described elsewhere in this document can also be used as an alternative or supplement these materials.

All of the layers provided in the laminate 1400 (that may be used as the barrier layer 1100 of FIG. 17) can be secured together using any combination of a number of securing approaches, including the use of glue, heat bonding, stitching, quilting, or other means, or any combination thereof, to secure the various layers of the laminate together. Hence, the laminate can be manufactured using stitch bonder or quilting machines, leading to a multi-layered laminate having a plurality of flexible layers and leading to a flexible laminate. Note that each layer might be comprised of thin, solid sheets of any of anti-ballistic material or the material could be woven into a durable and tough and flexible fabric using threads and/or fibers of the material.

An aspect of the first surface that the bullet hits can be designed to act like a strike face, to slowdown and deform/mushroom the bullet before it hits the inside layers which then stop the projectile. For example, the outside layer can be anodized, coated, plated or treated/coated to provide the first task of slowing and deforming the bullet before it hits the layers that do the heavy lifting.

The outside strike face can have ridges or protrusions to roll the bullet. There could also be a ceramic veneer or layer to act as the strike face. The strike face layer can also be a combination of different technologies such as coating a ceramic veneer, such as to keep the weight down.

The whole barrier assembly can be spring loaded or partial break away to dissipate energy, or to move in an X, Y or Z direction. The strike faces could slide in pockets of the barrier. The hinges can be metal or composite based.

A security film can be applied to the strike face to slow down and mushroom the projectile such as a bullet. The material would not be flammable like glass and other methods currently used, would be safer for schools etc. On lightweight metal barriers or blinds (having metal slats) a coating or layer/foam, or lightweight material slides in to the extrusion or stamping.

The barrier shape can be used to change the roll of the bullet, various angles to get bullet on its side, for example. The point of the first, outer layer (other than surface decorative layer(s)) is to act as a strike face and slow down and mushroom flatten out the bullet/projectile. When glass is in front of the barrier, a security film can be applied to a surface of the glass that acts as a strike face to slow down the bullet.

On light weight metal barriers (e.g., shutters or blinds) a coating or layer of lightweight material such as Tensylon that fastens or slides into the extrusion or stamping. The barriers could also be a clear lexan that darkens with sunlight. The barriers or shutters could also be a laminated/sage glass that darkens automatically or when electricity is applied.

Barriers can also be a shutter made of tensylon that has a metal, ceramic or wood veneer surface, to make that barriers more presentable but also act as a strike face. The slats or edges can also have a metal edge to improve the appearance. Lightweight materials light dyneema can act as a ladder or to keep the barriers aligned. A metal shutter can be a extrusion or stamping that the cavity is filled with a combination of materials foam, coating, kevlar polyurethane, or anti-ballistic gel, depending on the function of providing strength, sound dampening, strike face, decorative, etc. The fabric laminate may also be coated with various substances to help provide decorative features, or to stiffen outer layers to deform bullets, or to provide sound deadening, or otherwise provide other desirable features.

The barriers can be provided in modular sections that can deploy horizontally or vertically. The device can deploy from the top bottom or side. Sections can be provided in fabric or hinged, daisy chained, or wired together. Speakers and/or lights can be provided in various sizes.

The sections can be electrostatic or the equivalent of a thin speaker to block light sound bullet etc. (as described in more detail below). The barriers can provide light or emitted sound. Barriers, such as blinds or shutters can use speakers for security, and can block light and provide sound. Speakers can be provided to vibrate the barriers do active noise cancellation.

Barriers can be designed in a way to dissipate the energy from the shot through motion, destruction, heat dissipation, deformation, or other processes. They may sacrifice themselves much like a formula one car sacrifices itself to save the driver.

A cavity or pockets of the barriers (e.g., blinds or shutters) can be provided to house different modules according to the needs desired or a combination of elements. Slats could rotate on there axis to displace energy or change side according to purpose.

The barriers can be comprised of various layers of fabric material. The material layers may be secured to each other by stitching, quilting, gluing, welding, or merely the edges may be bound and perhaps tacked in a few spots leaving inner layers unsecured to each other, allowing motion or pockets for other uses, such as inserting materials or gels. Perhaps not stitch bonding or perhaps a very open quilt pattern.

A logo can be provided, such as using 1 inch or ¾ inch binding, or by sewing in a logo. As many as 18 plies or more of woven Kevlar fabric or other material can be used in the laminated material. Depending on the weave and year size, the result can meet at least a level IIIa protection, or more. Fabric style can be 600d Kevlar KM2 Plus, 24×24 square yarns per inch, plain weave construction, Polyester stitching yarn, 75 denier textured yarn. Stitch pattern can be: linear chain stitch (machine direction), 3.5 gage spacing. Quilting can be used to secure the layers to each other. Layers secured only at the ends can also be utilized. It is noted that the very looseness, flexibility, and motion of the material aids in energy absorption, providing better ballistic protection and penetration avoidance.

Referring back to FIG. 17, the barrier layer 1110 will be fixed at one or more ends using either or both top mounting structure 1120 and side securing structures 1140 to securely connect to the structure 1150 of the building or vehicle. These structures will securely fix one end of the barrier layer 1110 to a secure part of the structure, such as a window or door frame, a ceiling, or vehicle panel or frame. Note that where the barrier is of a deployable embodiment, the top mounting structure 1120 may include features that retract and/or store the barrier layer 1110, such as disclosed in a number of the parent applications in embodiments such as deployable window blinds.

In this generic approach, as discussed above, the barrier layer 1110 will be a flexible layer that can move, vibrate, swing, and otherwise convert the kinetic energy of the ballistic projectile into kinetic and/or heat energy in the barrier 100 by nature of having barrier sides 1112 and a barrier bottom 1114 that are not secured to any structure in this free hanging embodiment. A weighted end 1130 can be provided on the barrier layer 1110 to add mass to the barrier so that the kinetic energy of the projective is also transferred to this mass as kinetic energy by moving the mass of the end 1130, which can include lifting the end, swinging the end, and other types of motion. The end 1130 also helps keep the barrier 1100 in place by providing stability and in a deployable embodiment, may also help deploy the barrier 1100 in emergency situations, as is also discussed in the parent applications.

As an alternative, the securing structures 1140 may be extended further, even along the entire length of the barrier sides 1112, to secure the sides. Alternatively, they can be moved to a lower portion of the structure, to secure only at a bottom of the barrier. Furthermore, an optional floor structure 1152 can be provided at a bottom of the barrier 1100, such as on or beneath a floor, to secure the barrier bottom 1114 when deployed. For example, bottom 1114 may include a magnet along it's length as part of the weight 1130, and the floor structure 1152 could include a magnet of an opposite pole (which may be an electromagnet), to secure the bottom 1114 to the floor. Alternatively, floor structure 1152 might include a latch or gripping device that secures the bottom 1114 to the floor. Hence, in conjunction, extended or other located side securing structures 1140 and/or the floor structure 1152 secures the barrier 1100, when deployed, to prevent individuals or objects from passing beyond the barrier 1100 into a protected region.

Note that automatic deployment, based on the detection of a dangerous situation such as an explosion or gunshot (e.g., triggered by sound waves, breaking glass, light flash, or even detection of intruders, for example) can be provided as discussed in the parent applications. Manual deployment through activation of a motor or drop function through use of a switch, lever, or other manual activator can also be provided as an alternative or supplemental means of deployment. The weight 1130, when provided, can aid in quick deployment. Such barriers can be provided in windows, doorways, hallways, or even across rooms, for example.

Alternative approaches where the barrier is installed in a rising manner could also be provided. For example, posts may rise out of the ground or floor for deploying the barrier from the ground up, with the top portions free to move, or with sufficient flex in the barrier to allow freedom of motion. Such devices can protect hallways, stages, rooms, doorways, garage doors, or other locations in and out of buildings.

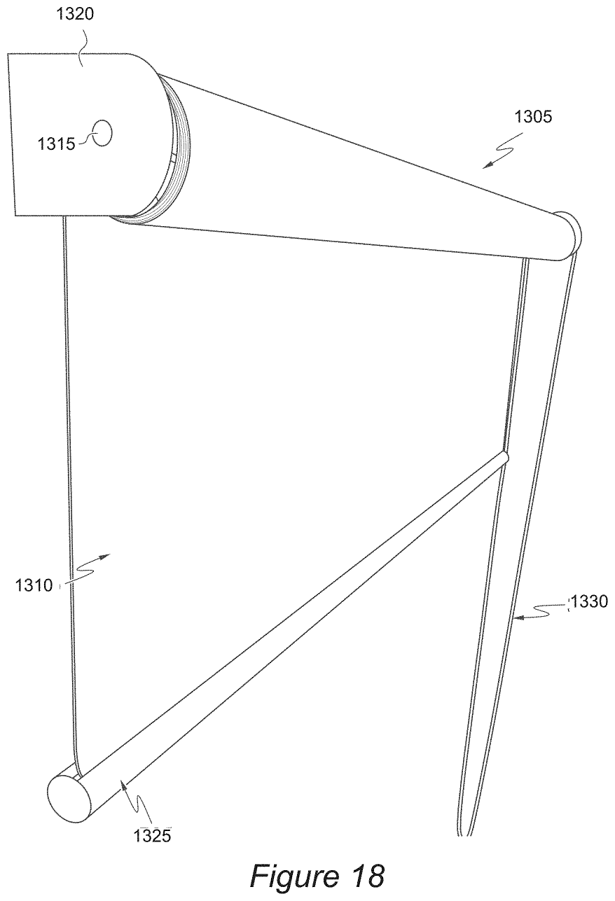

FIG. 18 shows a particular embodiment of a generic approach by providing a blind 1305 with support and stowing structures 1320, 1315 for deploying the barrier layer 1310 with weight 1325 in a window or door frame.

A blind could be formed using rotatable slats made of the fabric material described herein. Such slats could be formed having matching grooves or a tongue and groove system to allow the slats to interlock or overlap with each other in a more secure way to ensure better resistance to ballistic intrusion, as described elsewhere herein. For example, the slats might overlap by ½ inch.

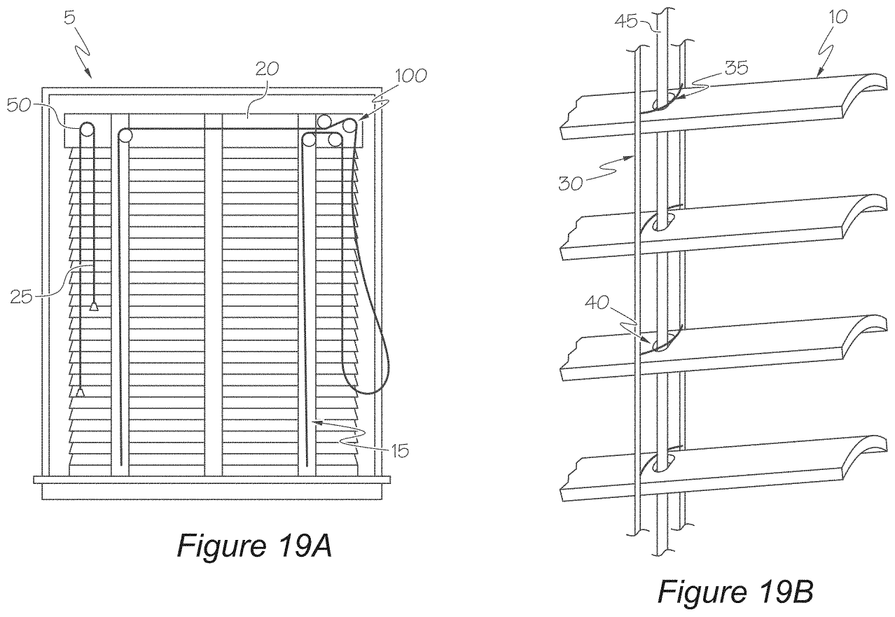

Referring to FIG. 19A, an example embodiment of a barrier system, such as a window blind system using slats, is shown. The blind system 5 includes a plurality of members such as slats, (also called louvers or vanes) 10 resting or hanging on the rungs of one or more ladders 15, which are movably suspended from a head, bottom or side rail 20, which may be mounted to a window or door frame. The slats 10 could be of horizontal or vertical orientation.

The slats could be formed having matching grooves or a tongue and groove system to allow the slats to interlock or overlap with each other in a more secure way to ensure better resistance to ballistic intrusion, as described elsewhere herein. For example, the slats might overlap by ½ inch.

The slats 10 can be of conventional construction but with updated materials, and can be constructed of a number of different materials having desirable properties, including, but not limited to, the following materials: plastic, composites, wood, metal, fabric, fiberglass or any other suitable anti-ballistic material including, but not limited to, Kevlar® (which is a synthetic fiber of high tensile strength comprised of poly-para-phenylene terephthalamide) or Lexan® (which is a transparent polycarbonate of high impact strength) or Lucite® (which is a solid transparent plastic comprised of polymethyl methacrylate) or DuPont™ Tensylon® (which is an ultrahigh molecular weight polyethylene anti-ballistic material), or a plexiglass with anti-ballistic properties, for example, or any combination thereof. Other materials or combinations described elsewhere in this document can also be used as an alternative or supplement these materials.

In an example embodiment, the slats could be provided as a laminate, such as steel or aluminum with a carbon fiber or tensylon or fiber glass backing. Decorative layers or paints can be provided for room esthetics. Also, fabric can be treated with boron to form a ballistic resistant material. For example, a fabric can be dipped into a boron solution, then heated in an oven at more than 1000° C., which changes cotton fibers in the fabric into carbon fibers, such that the carbon fibers react with the boron solution to produce boron carbide.

The slats 10 could vary in shape, width, thickness, and/or orientation to form blinds of various styles and construction, as desired. The slats 10 can be made flat or curved across their transverse dimension, they can be of any desired width or length or thickness, and they could be provided of different dimensions, such as, for example one, two, three, or four inches wide or any other suitable width for the desired application. Rather than horizontal slats, the slats may be arranged vertically, as shown elsewhere in this document. The lengths of the slats for the various blind designs can be varied according to the window or door size that they are being utilized to protect, and they could be of a length of a foot or more, up to 4 to 8 feet or more, as desired. Vertical blinds with slats could be similarly arranged.

Turning to the operation of the slat blind system 5, the slats 10 can be tilted (e.g. by rotation) by a tilt mechanism 50 to let in partial light, such as when a tilt wand or cord 25 is used to adjust the slats 10. The slats 10 can also be lifted or collapsed by a lift mechanism 100 (for example, to fold or accordion the slats into a compact position) to let in full or nearly full light, for example.

Referring to the example embodiment of FIG. 19B, the slats 10 are suspended by the ladder 15 which is comprised of at least two strips of cloth or string or tape 30 that allows the slats 10 to be suspended in a manner such that all slats 10 in unison can be rotated nearly 180 degrees, such as to go from an open condition (state) to a closed (protective) condition (state). The tape 30 can be made of any flexible material such as fabric, plastic, nylon, polyester, or any flexible material or the like. The ladder 15 further comprises a connector tape 35 which connect the two strips of tape 30 together. Rotating the tilt-cord 25 causes the slats 10 to rotate/tilt a longitudinal axis in order to open or close visual access to the outside from inside the room in which the blinds are installed.

As an alternative to rotation, in some embodiments the slats may be opened and closed by sliding the slats or collapsing the slats together, for example. And the entire blind may be retracted toward the top (valence) structure or deployed as desired.

The slats 10 of the blind system 5 further comprise rods 45 routed through rod holes 40. In this example embodiment, each slat 10 comprises at least one rod hole 40. At least one steel rod 45 which is affixed to the head or bottom rail 20 runs through each slat 10. The slats 10 could pivot about the steel rod 45 which is encased in the slats 10. Pulling the lift-cord activates the lift mechanism 100 causing either the bottom rail or the top rail to rise, sequentially collecting the slats from the bottom up or the top down and compressing the entire array of slats 10 against the top-rail.

In an example embodiment, the slats 10 may have a groove and and/or tongue that may run the length of the slats 10 to interlock the slats together during deployment. While the embodiment shows the groove runs the length of the slat, it is appreciated that a groove-tongue system located at the edge of the slat may suffice. The groove and tongue allows slats to interlock when they are in a closed position for additional strength. In another example embodiment, the slats 10 can have fasteners that allow them interlock for additional strength. The fasteners could engage with the window or door sill for added strength, if desired. Or magnets or electromagnets might be used to interlock the individual slats together.

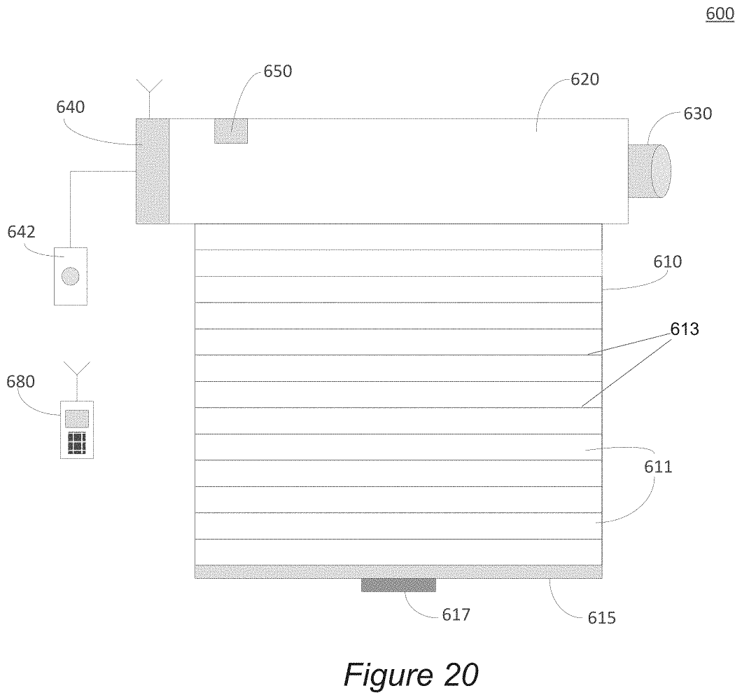

FIG. 20 shows an example anti-ballistic window blind 600 that is automatically deployable. The blind has a valance 620 for housing any necessary gearing or other transmission mechanisms to allow the motor 630 to deploy and retract the blind 610. The valance 620 may be decorative in nature to be pleasing aesthetically, or covered in a decorative cloth or covering. Controller 640 may be wirelessly capable to communicate with an external control unit 690, or a home defense system (such as an anti-burglar system) by wire or wirelessly. A panic button 642 might also be provided to quickly deploy the blind. The individual portions 611 are comprised of material to provide anti-ballistic protection that are between stitching 613, as described in more detail above, and may have decorative layers as well. Vibrator 650 may be provided to apply vibration to the blinds to hamper audio detection systems.

A weight bar 615 can be used to weigh the blind 610 to aid in deployment and stability, if desired. If desired, this weight 615 can be made of a magnetic material to be held in place by a magnet or electromagnet 617 provided on a window sill or floor or wall, such that the electromagnet is activated when a security situation is detected or otherwise triggered to better secure the blind 610 in place and improve its anti-ballistic performance. For power outages, the electromagnet may be battery powered, and only activated during as security event.

Alternatively, a mechanical or electrical latch or other structure could be used for the purpose of providing stability that might be placed at a bottom portion, or side portions, of the blind and secured to the structure, to provide stability to the blind during deployment and interaction with projectiles. Such structures might only engage when the blind is deployed, for example.

Alternatively, rather than a motor, the drive system 630 may utilize electromagnets or solenoids or pneumatic or hydraulic devices to retract and/or release the blind. For example, electromagnets may be used to hold the blind in a retracted position, for deployment during a security event by powering down the electromagnet when deactivated either by automated or manual means (as described herein), or by power outage, in which case the blinds, which can be weighted, can automatically deploy.

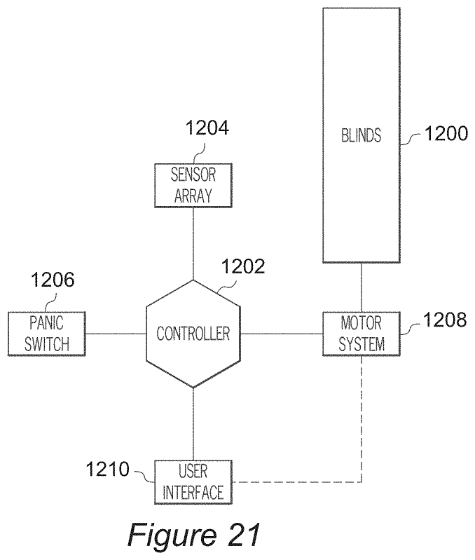

FIG. 21. Illustrates an example of a control system which may be used by any of the embodiments described herein to control the blind system 1200. The control system can include a controller 1202 with one or more sensors that form a sensor array 1204 connected to the controller 1202, and a panic switch 1206 connected to the controller 1202. The sensors may be pre-existing sensors in a home defense system or conventional after-market sensors capable of detecting ballistic signals such as sound (e.g., gun shots or breaking glass), gun powder, gun impact, muzzle flash, temperature, and the like. The sensors could be any of those typically used to detect a break in, for example. The controller 1202 is connected to a user interface 1210 whereby a user may activate and apply settings to the blind system. The controller 1202 is also connected to a motor system 1208 for actuating the blind system upon receiving information indicating that a threat is present and that the blinds should be closed (i.e., put into a protective state such as a ballistic protection mode).

Where a building may already have a central control system (e.g., a security or other alarm system), controller 1202 may utilize such a system by adding additional customized code for operating the blinds system 1200. In another example, the blinds could also utilize ground sourced radar, infrared (heat), sonar, or some other active or passive detection system. The sensor array 1204 can include one or more heat sensors, infrared sensors, video sensors, audio sensors, smoke detectors, or other types of sensors, or may utilize already existing sensors of a fire or burglar system, for example. Any of the sensors in the sensor array 1204, the panic switch 1206 or the user interface 1210, or any combination of these components, may be connected to the controller 1202 in a wireless manner, such as by WiFi or Bluetooth, for example, and the panic switch and/or user interface could be implemented on a cell phone or tablet computer, for example.

The system or any of its components may be controlled by any external or internal system, such as one that may exist prior to the installation of the blinds. For example, the blind system could be tied to an external system such as an alarm system or video cameras with analytics. The blind system could also be controlled remotely via the internet or a WiFi or Bluetooth connection by any connected device such as a tablet, computer, PDA, or a smartphone. Blinds such as disclosed herein would be very useful in a panic situation in a school or federal building. Such blinds could also be used in a lock down situation to prevent people or valuables from leaving the premises, for example. FIG. 9, described below, shows an example embodiment of a remotely controllable system.

The blinds could be retrofitted to an existing building or other structure, and adapted to tap into existing security or burglar alarm systems, for example, or they could be added during structure construction.

The blinds could also be adapted to sense the location of the occupants of the building and close by according to predetermined parameters such as direction of threat and the location inside the building that would be the best to return fire from. Blinds could also be controlled by facial recognition, video analytics, or by the occupants' voice or any other suitable biometrics, such as for recognizing an threatening person, such as an ex-spouse, or ex-employee who has made threats or acted in a threatening manner, or otherwise recognizing a wanted criminal or an enemy soldier, for example. When the blind system 5 is activated, the slats 10 may be configured to overlap each other to form the interlocking pattern discussed above so as deflect bullets, shells, or other ballistic weapons to prevent a fatal impact and/or property damage. Such blinds can protect from thrown objects as well, such as rocks, grenades, bricks, molotov cocktails, etc. Blinds could be controlled individually or together with a timing mechanism.

The blinds could be configured to protect against remote monitoring of sound and conversation, such as by providing random vibrations to the blind to avoid vibration detection by remote monitoring devices, for example.

As an example use, the blind system may be provided in an open state where the blinds are provided in an open condition (e.g., with open slats) to allow viewing through the blinds, or the blinds in a retracted position. The blind system sensor array would detect a potential intruder or the sound of gunfire using visual, auditory, or other sensed information. The system would then automatically enter a protective state, such as by closing the blinds (e.g., closing the slats) or deploying the blind (by lowering it to cover the window), or both, to protect the interior of the room from external entry of projectiles (e.g., bullets), for example. Or the system may detect the entry of a ballistic projectile (e.g., a bullet, rock, etc.), or threatening shouts or yells, sirens, explosions, proximity of threatening individuals, etc., in which case the blinds would be activated into a protective mode.

In a vehicle application, the blind system could be controlled with safety in mind so that a driver does not lose all drivability at once and improving the ability to evade. For example, the blinds could have a small port hole for the driver of the vehicle to see out of to allow the driver to continue to drive toward a safer area, for example. Or the blinds could be comprised of a transparent material with anti-ballistic properties, or a material with anti-ballistic materials woven therein.

In use for mobile applications, such as in boats, or airplanes or automobile, the blind system could be configured to tilt or close the blinds based on temperature, sound, threat, geographic terrain, environmental conditions and any outer suitable factors. For example, as a vehicle goes up a hill, the blinds can be adapted to tilt so that air or light can get in and not bullets.

The blind system could also be fire rated to prevent fire from spreading to the next room or structure through the use of fire retardant or preventive materials, where the blinds can be automatically closed when a fire is detected through monitoring of temperature, light, or infrared, for example.

As described above, the blind system may have a roll up blind (e.g., window shade) configuration that may utilize an anti-ballistic fabric material for example, and that can be used as protective covering to protect equipment such as, for example, a radiator, or a ventilation system, or on an intake area of a jet engine, engine, window, radiator, or gas tank of an automobile (or other vehicle), or any other suitable protective covering applications. The roll-up blind system may be made of bullet resistant fabric such as Kevlar or Lexan or DuPont™ Tensylon®. Other materials described herein could also be used, as an alternative or to supplement these materials. In such a system, the blind may be comprised of a contiguous sheet of material, or patches of such material, rather than slats.

In an alternate example embodiment to the slat blind system, the roll up blind system can reside between two glass panes, such as safety glass panes for use in applications like automobiles, airplanes, boats or other mobile applications. Such a system might utilize a Kevlar curtain that falls between windows panes, or even in front or behind a single pane.

Any of the protective blinds described herein might also be stored in a ceiling rather than a valance structure, and in some cases bullet proof panels rather than blinds might be used, where deployment in emergency situations means that the blinds drop from the ceiling to provide ballistic protection.

The barrier could also tilt or otherwise be operated according to the threat or terrain. The barrier could close from the top or bottom depending on the design of the building or application. The barrier could also run left to right, for example. The blinds could also tilt according to the threat or terrain. For example with vehicle application when the barrier is used as a radiator cover, as the vehicle goes up a hill the radiator blinds tilt so air can get in and not bullets.

Referring back to FIG. 18, the roll up barrier system may be used for windows, doors, entryways, or any other desired application in a building or vehicle. The roll up barrier system could suspend from a rail and that may be disposed within a head box 1320 (acting in concert at a valence) and may be weighed down by bottom rail 1325 to maintain its position and add structural strength, or provided with side structures that engage when the barrier is deployed. The weight of the bottom rail can vary to match the desired application, or it may be paired with a structure enhancement such as through the use of electromagnets or a structure secured to a sill or floor. A reel cord 1330 may be used to be roll up the blinds 1310 or to roll down the blind 1310. The reel cord 1330 may also be pneumatically or automatically driven, such as by using a chain. The lengths of the blind 1310 can be varied according to the window or door size that they are being utilized to protect, and they could be of a length for the desired application.

Generally, any of the blind systems provided herein will typically be provided with blinds that can be placed in an open state at the request of a user to enable viewing through the blinds, and/or to allow for airflow and/or light flow and/or other flow through the blinds. Such blinds can also be closed at the request of a user, in which case the blinds may also be in a protective state. The blinds can also be provided in an intermediate state, able to both provide some limited ballistic protection and to let in a substantial amount of light. Upon detection of a threatening condition, such as detection of a gunshot or a flying projectile, or by activation of a panic button or security system, blinds that are in an open state will be transitioned into a closed, protective state to protect against ballistic projectiles or other threatening materials.

In addition to the embodiments disclosed in the '206 application and described above, various forms of vertical blinds based on concepts provided in that application are also provided. Additional materials are also disclosed for constructing the blinds in this and that application.

The use of a Kevlar fabric having expanding baffles between the layers is one alternative in such blinds. By providing baffles in the material, the material is enabled to expand in an outward direction, which will help to absorb some of the energy provided by a ballistic impact.

The fabric blinds could utilize horizontal or vertical pleats or slats. Separate vanes or material can be provided to add bullet proof functionality, such that existing blind designs, that may have ornamental aspects, can be supported by a set of bullet proof blinds placed underneath the current blind design. The blinds would act in conjunction to open and close in a traditional manner, with the added functionality of providing ballistic projectile protection. Solenoids or motors, or electromagnets, or other electrical or mechanical devices can be used to mechanically open and close the blinds.

In some options, a bullet proof blind (that may be provided behind or in front of a traditional blind or a as a full replacement) may remain normally in a retracted or otherwise open mode. The bullet proof portion of the blind may be hidden in a valence of the blinds, for example, or be rotated or retracted in an open position. The bullet proof material can be automatically deployed, such that upon a triggering event (such as the detection of a gunshot, or the triggering of a proximity alarm or other type of burglar alarm, for example) the bullet proof (ballistic) blind would then deploy, such as by dropping into place from a valance or roof or ceiling, for example.

Such a dropping ballistic blind might be comprised of panels or slats of ballistic material that are folded, overlapped, or otherwise collapsed in the retracted position, or it may comprise a roll of ballistic fabric that rolls to retract, and unrolls to deploy to form a ballistic layer of protection. A weight may be provided at the bottom of the roll to aid deployment (e.g., unrolling) and to help keep the material in place for stopping or slowing the projectiles. Alternatively, some structure to increase the strength of the deployed blind could be used, such as electromagnets or electrical or mechanical latches at the base to secure the deployed blind to the floor or window sill or wall or other structure.

The blinds can be placed between layers of glass, for example, which can be used in original installations or to retrofit existing windows. The blinds may be used in conjunction with bullet proof or bullet resistant glass. For example, blinds such as disclosed in U.S. Pat. Nos. 5,826,338 & 6,070,638, incorporated herein by reference, could be modified using the materials disclosed herein to add ballistic protection to such blinds. Automatic deployment functions, as also described herein, could also be provided.

In particular, vertical blinds (or shades) can be used to provide bullet-proof protection, as described herein. Such blinds, although they may use hanging panels, can still provide ballistic projective protection by absorbing energy from a bullet or other projectile. Such a device may be comprised of a plurality of panels made of a ballistic material. Acceptable materials may include a high-density polymer (e.g., polyethylene, Tensylon), ceramic, metal (e.g., steel, titanium, and alloys thereof), aramid fiber (e.g., Kevlar), polycarbonate (e.g., Lexan), fiberglass (ArmorCore, see www.armorcore.com), carbon fibers, and other carbon structures, boron treated cloth, etc. and combinations thereof. Ballistic cloths can be used for such panels, such as by laminating such cloths, with or without other materials.

The blinds can be made with slats in more than one thickness. For example, two different thicknesses including ¼ inch or ½ inch thick slats may be provided. The blinds might have slats with a width of 3 inches, among other widths, as desired. The blinds can overlap (e.g., when closed) more for additional support and protection, and may include structure to enhance structural strength. Different types of cord for the panels to hang from, including exotic fibers such as boron and composite fiber, can be utilized. The blinds could fasten at the bottom or sides for additional strength and stability.

As examples, slats made from ArmorCore can be provided of dimensions 2″×36″×0.35″ (weight=1.9 lbs./slat) Slats made from Tensylon can be provided of dimensions 2″×36″×0.23″ (Total weight=0.6 lbs./slat).

Shades can be provided that are of a uniform material that don't use slats, but instead use one or more uniform layers of ballistic material, which may or may not be laminated, and may even be formed into panels or slats. Such shades can drop automatically, as described herein for the blinds. The shades may be opaque (blackout shades), or somewhat transparent (translucent) or totally transparent, or otherwise have small or large gaps to let light through, as desired. Multiple layers of material can be used in the shades, and the shades may be used in combination with the blinds to add extra protection. For example, the shade may automatically deploy (drop) when a ballistic event is detected, while blinds may automatically close (such as by rotating the slats).

In contrast, a fixed barrier might be deployed within the door body panels, or other hollow body locations, that is permanently deployed within the door and attached to the door frame to add anti-ballistic properties to the body of the door. Such a barrier might have the upper portion attached to the door frame but hang freely within the door panels within free space in the door to provide the benefits of such a structure as described herein. The barrier would then absorb the energy of a projectile as described above. Such a barrier could be installed during manufacture of the vehicle, or might be provided as an after-market installation to add anti-ballistic properties to existing vehicles. The window blinds might also be added at the factory or as an after-market add-on.

For example, the flexible barrier in, say, a 3.5 inch door cavity takes up about ¼ inch to 1 inch of the overall space. The shock wave that goes across the material from the projectile dissipates the energy through and across the whole piece of material rather than just a small area directly around the projectile when the material is affixed to the strike face of the door. The shock wave dissipates the energy more efficiently through the material than would a fixed barrier.

Other options for use in vehicle door panels and other hollow bodies include inflatable bags that can fill with an anti-ballistic gel, sand, balls or other material to provide anti-ballistic protection. Airbag type devices might also be provided that deploy outside of the body panels to protect individuals inside the vehicle, where such airbags might be comprised of anti-ballistic inflatible sheets as discussed herein or filled with anti-ballistic material such as a gel. Such systems may be automatically or manually deployed, or permanently deployed, all of which is discussed herein and in the parent applications for various barrier embodiments.

The blinds or shades can be utilized in vehicle applications, such as currently blinds that are provided in some vehicles, such as in limousines or luxury vehicles, for example.

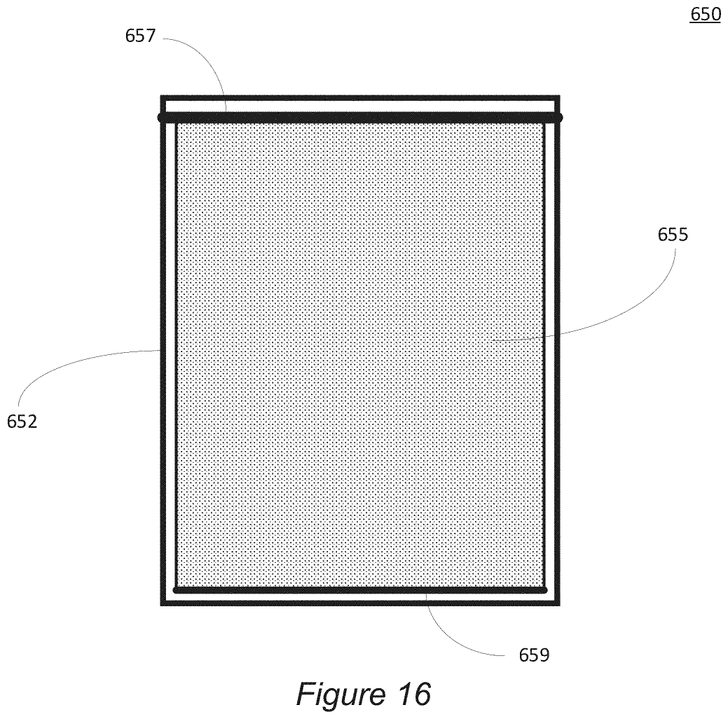

FIG. 16 shows an example blind 650 that could be used in a vehicle, such as an automobile or even an aircraft. The window 652 is fitted with an antiballistic blind 655 that is deployed from valence 657 that is mounted in the window, or might be mounted in a roof of the vehicle. A weight bar 659 might be provided to ensure that the blind properly deploys, such as by gravity. Such blinds would more likely not be venetian style, but instead be solid sheets of material, as discussed herein, that drop manually or automatically upon detection of an emergency condition.

The blind could be deployed in a manner similar to that discussed above with respect to other blinds, and these vehicle blinds might also have adjustable blades/louvers, which can have a groove that runs the length of the louver. This groove or notch can allow the louvers to interlock for additional strength. With either the home/commercial application or the automotive application the blinds can be electronic and close automatically when gunfire is sensed. The front windshield one could close partially or slowly according to the speed of the vehicle. The blinds could have fasteners that allow them to interlock. The blinds could also engage with the window sill for added strength. There could also be 2 or more layers of blinds depending on the threat. This would also allow light in but keep bullets out.

Such blinds may be deployed in school buses, public transportation (busses, trains, trolleys, taxis, even planes, for example) to protect children or other members of the public in battlefield areas or in dangerous cities or sections of cities, for example. Schools and other public buildings could be provided with such blinds, for example.

The blinds could be used to retrofit existing vehicle blinds that do not have bullet-proof or other ballistic features, or they could be installed as original equipment or as after-market add-ons.

The vehicle blinds could be configured to vibrate at a random or constant rate, as described above, to prevent an interferometers or vibration sensing listening devices from working through the blinds, avoiding eavesdropping or other spying activities. Vibration can be applied to the blinds through use of motors or piezo devices in a manner known in the art to create vibrations. Such blinds may be ideal for board rooms or military planning rooms to avoid spying operations.

Note that blinds that are constructed of ceramic or composite ballistic material can be much lighter and cheaper to build than blinds that use metallic materials, such as steel, for example, and they could prove flexible and more deployable and retractable.

Blinds using fabric and/or panels held together by fabric can be utilized. Also having blinds in a horizontal or vertical position. Closing and opening from all possible sides can be provided, e.g., from the top or bottom or left or right. Also a combination of these approaches can be used. Blinds could close from both sides. Or close from the top and bottom where each blind half covers half of a particular window.

Roll down fabric blinds using ballistic materials that come down from the top, such as that can be quickly deployed can prove useful. Also panels that fold down from the top can be utilized.

Ballistic resistant panels can be provided with the ballistic material provided on back of an ornamental design (e.g., wooden slats), or between ornamental designs, so that the blinds provide traditional ornamental aesthetics. The ballistic materials may be woven into a layered cloth that can be attached, glued, or otherwise combined with the ornamental panels to achieve the desired effect. A string or rope made of the ballistic material can be used to replace the string/rope that may be utilized in existing blind applications.

For vertical blinds such as shown in FIG. 1A, the blind panels from a support structure, and they can be pulled to a side horizontally to open the blinds. The slats may also be rotated to open the blind to light, or to block the light or provide privacy, such as at night. Such a system may be automatically deployed (i.e., closed) by both extending the blind, and/or rotating the slats closed, depending on the current state of deployment, to provide ballistic protection when a threatening event is detected, as discussed above.

Ballistic blinds might also be arranged in a manner similar to drapes, where ballistic fabric is used to form the bullet proof drapes. In this case, the drapes can be deployed in a manner similar to fabric drapes. Vertical slats can be used in such approaches as well, where the slats fold together when the “drapes” are withdrawn (opened), and unfold when the “drapes” are deployed (closed).

Note that blinds could also be installed in the interior of rooms or against walls with the structures being installed at the ceiling or above a drop ceiling, so that the blinds can be dropped when needed for protecting a wall or room. Automatic deployment can occur as discussed above for window blinds. It has been found that free-hanging blinds can actually perform better than blinds that are secured at the bottom or sides, likely due to better energy dissipation properties when the blind is permitted to move upon impact with a bullet or shrapnel. Hence, blinds without being secured at the bottom and sides are of particular interest and make up some preferred embodiments, although a weight may be used on the bottom edge of the blinds to aid in deployment.

An alternative blind design could utilize thin layers of glass with graphene centers or Lexan between two layers of glass that may be transparent or translucent sheets or slats. A transparent or translucent anti-ballistic gel might also be used, such as shear thickening fluids that are transparent to fill the gaps between window panes or layers of glass. Some of these materials harden upon impact and might be comprised of non-Newtonian fluids that that thicken in response to force (such as mixtures of cornstarch and water do). Examples of such materials have been disclosed recently but their composition are trade secrets. See www.sciencealert.com/liquid-armour-is-now-a-thing-and-it-stops-bullets-better-than-kevlar and www.telegraph.co.uk/news/uknews/defence/4862103/Military-to-use-new-gel-that-stops-bullets.html for examples.

It is desirable that the blinds meet NIJ level IIIA standards or above. Large sheets of material can be formed which are then water jet cut to 2.5″×36″ strips of material out of the larger sheets for slats, for example.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of producing a sheet of flexible ballistic resistant laminate comprising the steps of:
providing a first sheet of material including a ballistic resistant material into a bonding process;
providing a second sheet of material including the ballistic resistant material into the bonding process;
providing a third sheet of material including the ballistic resistant material into the bonding process; and
using said bonding process to bond said first sheet of material, said second sheet of material, and said third sheet of material together to form said sheet of flexible ballistic resistant laminate, wherein
said sheet of flexible ballistic resistant laminate is sufficiently flexible to be rolled into a roll; and wherein
said sheet of flexible ballistic resistant laminate is configured to prevent a ballistic object including a bullet and/or explosive shrapnel from penetrating the sheet of flexible ballistic resistant laminate.

2. The method of claim 1, wherein said ballistic resistant material includes Kevlar or another poly-para-phenylene terephthalamide.

3. The method of claim 1, further comprising providing a plurality of additional sheets of material into the bonding process to form said flexible ballistic resistant laminate.

4. The method of claim 3, wherein each one of said additional sheets of material include some type of ballistic resistant material.

5. The method of claim 3, wherein at least one of said additional sheets has fire resistant properties.

6. The method of claim 1, further comprising providing a decorative sheet of material into the bonding process to form a decorative outer surface on said flexible ballistic resistant laminate.

7. The method of claim 1, wherein said anti-ballistic material includes boron.

8. The method of claim 1, wherein said ballistic resistant material includes Dyneema or another ultra-high molecular weight polyethylene.

9. The method of claim 1, further comprising the step of spraying a substance on at least one of said first, second, and/or third sheets before or after said bonding process.

10. The method of claim 9, wherein said substance includes an adhesive, and wherein said spraying step is performed prior to said bonding process.

11. The method of claim 9, wherein said substance provides a decorative outer layer.

12. The method of claim 9, wherein said substance includes a fire resistant material.

13. The method of claim 1, wherein said first, second, and third sheets of material are comprised of a woven fabric including the anti-ballistic material as threads, yarns, or fibers.

14. The method of claim 1, wherein at least one of said first, second, and/or third sheets of material is an unwoven mat including the anti-ballistic material as fibers.

15. The method of claim 1, wherein said bonding process includes the step of stitch bonding the first sheet of material, the second sheet of material, and the third sheet of material together.

16. The method of claim 1, wherein said bonding process includes the step of stitch bonding the first sheet of material, the second sheet of material, and the third sheet of material together in a regular pattern of transverse stitches spaced equally apart along a longitudinal length of said sheet of flexible ballistic resistant laminate.

17. The method of claim 1, wherein said bonding process includes the step of adhesive bonding the first sheet of material, the second sheet of material, and the third sheet of material to one another to form said sheet of flexible ballistic resistant laminate.

18. The method of claim 1, wherein said bonding process includes a step of welding at least one of the first sheet, the second sheet, and/or the third sheet to an adjacent one of the first sheet, the second sheet, and/or the third sheet.

19. A ballistic barrier produced utilizing the sheet of flexible ballistic resistant material produced by the method of claim 1.

20. A method of producing a sheet of flexible ballistic resistant laminate comprising the steps of:
feeding a first sheet of material including a first ballistic resistant material into a bonding process;
feeding a second sheet of including said first ballistic resistant material and/or a second ballistic resistant material into the bonding process;
feeding a third sheet including said first ballistic resistant material, and/or said second ballistic resistant material, and/or a third ballistic resistant material into the bonding process; and
using said bonding process to bond said first sheet, said second sheet, and said third sheet together to form the sheet of flexible ballistic resistant laminate; wherein
an outer decorative layer is provided on an outer surface of the sheet of flexible ballistic resistant laminate, and wherein
said sheet of flexible ballistic resistant laminate is configured to prevent a ballistic object including a bullet and/or explosive shrapnel from penetrating the sheet of flexible ballistic resistant laminate.

21. The method of claim 20, wherein said bonding process includes the step of stitch bonding the first sheet of material, the second sheet of material, and the third sheet of material together.

22. The method of claim 20, wherein said bonding process includes the step of stitch bonding the first sheet of material, the second sheet of material, and the third sheet of material together in a regular pattern of transverse stitches spaced equally apart along a longitudinal length of said sheet of flexible ballistic resistant laminate.

23. The method of claim 20, wherein said bonding process includes the step of adhesive bonding the first sheet of material, the second sheet of material, and the third sheet of material to one another.

24. A ballistic barrier produced utilizing the sheet of flexible ballistic resistant material produced by the method of claim 20.

25. The method of claim 20, wherein said ballistic resistant material includes Kevlar or another poly-para-phenylene terephthalamide.

26. A method of producing a sheet of flexible ballistic resistant laminate comprising the steps of:
feeding a first sheet of material including a woven ballistic resistant material into a bonding process;
feeding a second sheet of including said woven ballistic resistant material into the bonding process;
feeding a third sheet including said woven ballistic resistant material into the bonding process; and
stitch bonding said first sheet of material, said second sheet of material, and said third sheet of material together using a regular pattern of transverse stitches spaced equally apart along a longitudinal length of said sheets to form the sheet of flexible ballistic resistant laminate; wherein
said sheet of flexible ballistic resistant laminate is configured to prevent a ballistic object including a bullet and/or explosive shrapnel from penetrating the sheet of flexible ballistic resistant laminate.

27. The method of claim 26, wherein said ballistic resistant material includes Kevlar or another poly-para-phenylene terephthalamide.

28. A barrier produced utilizing the sheet of flexible ballistic resistant material produced by the method of claim 26.

29. The method of claim 26, further comprising the step of providing an outer decorative layer to said sheet of flexible ballistic resistant laminate.
